(19) United States
(12) Patent Application Publication
(10) Pub. No.: US 2021/0192650 A1
(43) Pub. Date: Jun. 24, 2021

(54) SYSTEM AND METHOD FOR MANAGING DATA STATE ACROSS LINKED ELECTRONIC RESOURCES

(71) Applicant: Clause, inc., New York, NY (US)

(72) Inventors: Peter Geoffrey Lerato Hunn, Dallas, TX (US); Adel El Messiry, Brentwood, TN (US)

(21) Appl. No.: 17/101,991

(22) Filed: Nov. 23, 2020

Related U.S. Application Data
(63) Continuation of application No. 15/963,786, filed on Apr. 26, 2018, now abandoned.
(60) Provisional application No. 62/490,144, filed on Apr. 26, 2017.

(51) Int. Cl. G06Q 50/18; G06F 9/54; G06F 16/901; G06F 16/904; G06Q 30/00

(52) U.S. Cl. CPC G06Q 50/18; G06F 9/547; G06Q 30/018; G06F 16/904; G06F 16/9024

(57) ABSTRACT

A system and method for managing data state across linked electronic resources comprising: database storage comprising a set of electronic resources that are programmatically integrated with external data sources, wherein the electronic resources comprise: at least one programmable component that comprises computer executable instructions that define: state objects, a logic component, and one or more attributes describing the electronic resource; and one or more processors configured to: determine a subset of the set of electronic resources; retrieve values from state objects from the subset of the set of electronic resources; extract external data based on logic of an electronic resource; aggregate state objects and external data into a graph data structure; compute, based on the one or more state objects and the graph data structure, a visualization data set describing the subset of the set of electronic resources; and render, based on the visualization data set, a visualization.

### CROSS-REFERENCE TO RELATED APPLICATIONS

This Application is a continuation application of U.S. patent application Ser. No. 15/963,786, filed on 26 Apr. 2018, which claims the benefit U.S. Provisional Application No. 62/490,144, filed on 26 Apr. 2017, both of which are incorporated in their entirety by this reference.

### TECHNICAL FIELD

This invention relates generally to the field of contract business intelligence, and more specifically to a new and useful system and method for business intelligence through data-driven contract analysis.

### BACKGROUND

A contract is a legally enforceable agreement to exchange value such as goods, services, or property. Contracts are a fundamental tool for coordinating economic activity. Four of the basic stages of contracting are: formation, performance, renegotiation and amendment, and termination. Written contracts are typically paper-based or computer-based digital representations of paper-based contracts. Contracts are typically made of up numerous distinct clauses that establish basic information and contain the parties' rights and obligations. Clauses may be made up of a single sentence or a paragraph, and are grouped together topically, and often hierarchically, by sections. Contracts are typically structured so that clauses make intra-document references to one another, either in the same section or across different sections. Modern contracts are typically made up of the following clauses and sections: a preamble, identification of the parties, recitals, definitions, the exchange of value and the parties' other obligations (including actions the parties should and should not undertake), representations, warranties, conditions, and several boilerplate clauses such as choice of law, assignment, and entire agreement (merger) clauses. Contract documents often incorporate by reference into the agreement, other documents, laws, and standards.

Contracts are currently static expressions. Although the external environment that relates to the contract and the parties' conduct pursuant to the contract may change over time, the terms and conditions of the clauses do not change after the contract is formed unless there is a legal amendment (modification). Contract amendment may require the assent of both parties; but it may be unilateral. Accordingly, under existing technology and practices, the contract serves as a static documentary record of the agreement as of the date of execution. This results in a need, often in commercial enterprises, to intensively manage legal contracts using contract management and Contract Lifecycle Management (CLM) software. CLM software typically operates by creating a centralized repository of documents that captures and/or extracts data, often from paper-based documents or PDF documents, relevant to the user's obligations under each contract. That data is stored and tracked to monitor the performance of obligations, manage business milestones, and provide the basis for basic analytics.

Analytics are used to assist in analyzing data contained within agreements. Currently, contract analytics are limited to analyzing data from natural language contracts (e.g. word processed documents and PDF documents) or metadata with respect to such agreements (e.g. number of contracts, negotiation status etc.). Whilst this is beneficial, natural language contracts are static in nature in that they do not provide any state beyond that at formation/execution. CLM software creates a system and layer of software and data separate from the actual contracts the CLM system assists in managing. This form of ‘management by proxy’ creates numerous inefficiencies in CLM processes, including (but not limited to): lack of visibility in execution, analysis of contractual performance, and lack of analytic value as limited data points are captured. A significant factor is that contract management does not enable real-time visibility of contract state. As the world becomes more data-driven and connected (e.g. through data from ‘Internet of Things’ (IoT) devices and platforms, edge computing devices, Application Programming Interfaces (APIs), blockchain/distributed ledger technologies), commercial relationships should—given that they pertain to the physical world—keep pace and be able to leverage and use data to analyze contracts and contractual relationships.

Similarly, enterprises are increasingly making use of data analytics and Business Intelligence (BI) systems to assist in decision-making. This increasingly data rich environment offers significant potential for improving business results by making decisions that are increasingly data-driven. Various forms of analytics may be used to assist in commercial decision-making, but these are not being effectively leveraged in respect of contractual relationships.

Thus, there is a need for a system and method that enables contracts that are capable of using data to be analyzed using their state, and provide actionable insights, metrics, and data visualization. This invention provides such a system and method.

Thus, there is a need in the business intelligence field to create a new and useful system and method for business intelligence through data-driven contract analysis. This invention provides such a new and useful system and method.

### BRIEF DESCRIPTION OF THE FIGURES

FIG. 1 is a schematic representation of a system of a preferred embodiment;

FIG. 2 is a schematic of an alternate system of a preferred embodiment;

FIG. 3 is a schematic example of data hierarchy depicting the definition of contract related data and its subsets;

FIG. 4 is a schematic example of a data hierarchy depicting the definition of contract related data and its subsets in context of a contract corpus;

FIG. 5 is a schematic representation of a variation of a method of preferred embodiment;

FIG. 6 is a schematic depicting a more detailed view of the data processing and visualization components in one embodiment of the system and method;

FIG. 7 is a schematic depicting one embodiment of the system and method, including event stream processing and storage of enterprise data;

FIG. 8 is a high-level overview of a process depicting the exemplary treatment of a contract with hybrid computable and natural language clauses;

FIG. 9 is a schematic representation of an exemplary graph data structure of a contract comprising ‘Merklized’ edges, clause objects and composite atomic objects, demonstrating an exemplary state transition;

FIG. 10 is a schematic representation of an exemplary Merkle tree data structure of contract state;

FIG. 11 is a schematic that depicts an exemplary relationship between contract logic, data structure storage, contract management platform, and analytics functionality in one embodiment of the system and method;

FIG. 12 is a schematic depicting an exemplary input/output integration architecture with a server embodiment;

FIG. 13 is a schematic depiction of an exemplary server-based embodiment interacting with a repository system, a blockchain/distributed ledger system;

FIG. 14 is a schematic depiction of an outbound integration architecture; and

FIG. 15 is a schematic depiction of an exemplary abstraction of a contract management system.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for the dynamic, real time, analysis and management of data-driven contracts and contractual relationships using enterprise and contractual data is disclosed.

The system and method function to enable contract directed actions as a form of a business intelligence system. Business intelligence (BI) generally refers to technologies, applications, processes, and practices that relate to the collection, manipulation, integration, analysis, use, notification, storage, and presentation of business and other data. BI technologies provide historical, current and predictive views of business operations. To date, BI systems have been unable to effectively utilize contract data. This is significant as contracts are the foundation upon which commerce and corporate governance are built. Contracts are the core entity through which benefits, risks, rights, obligations, protection/indemnities, revenue, and liabilities are created and discharged. Indeed, legal and corporate governance theories posit that corporations and other forms of organization are a composite group or ‘nexus of contracts’. The system and method preferably enable corporations to leverage contracts as a mechanism for driving decisions and actions across various systems.

More specifically, the system and method function to acquire contract related data and perform a form of analysis across the contract related data such that some action can be taken. The system and method is preferably applied in situations where there is a plurality of related contracts that form a type of contract corpus. The contracts could be of similar types of contracts or a collection of different types of related contracts. Many business and organization operations will involve the creation, execution, and management of numerous contracts. In some exemplary implementations, a contract corpus can include hundreds or even thousands of contracts. The system and method can preferably extract and/or access data from these contracts such that higher-level analysis can be applied across them as will be described herein. The system and method could similarly be applied to a single contract.

Contracts are agreements that govern relationships between two or more parties.

Computable contracts are a form of legal agreement that are represented, entirely or partially, in a manner capable of being machine-readable. Computable contracts enable various forms of data to be captured pertaining to (amongst others) their state, and events that occur in respect of their operation and execution. This may include data relating to events on external systems as well as data created by the execution of the contract itself. ‘Data-driven’ contracts are a form of computable contract that exposes data inputs (e.g. from edge computing devices, ‘Internet of Things’ devices and platforms, event processing systems, webhooks, APIs, web services, ERP/CRM/IMS and other enterprise systems, blockchains/distributed ledgers, databases, events/operations performed by the contracting parties) to the contract to drive the logic of the contract, and also enables the contract to drive output-based operations on external resources. In one particular embodiment of a computable or data-driven contract, the contract may be comprised of programmable clauses. Programmable clauses are contract clauses that are expressed, wholly or partially, in computer code and may interface with the aforementioned external resources such as the ones discussed in U.S. patent application Ser. No. 15/476,791 filed on 31 Mar. 2017 which is hereby incorporated in its entirety by this reference.

One significant feature of data-driven contracts is that they may be dynamic in nature; meaning that a clause, part of a clause, or multiple clauses, may change or change other clauses. This change may occur in response to data, changes in other clauses, and/or other data-driven contracts, and/or other data from external resources. For example, a pricing clause may change its state in response to changes in temperature/humidity from edge computing devices if the price is made contingent upon such conditions (e.g. perishable goods in supply/freight agreements). Contract state updates may take place continuously and in ‘real-time’ or near ‘real-time’. Another significant feature is that contracts may perform transactions, store data on, or otherwise interface with blockchains/distributed ledgers in different ways. For example, data-driven contracts may interact with distributed ledgers/blockchains in various ways including (but not limited to): embedding, triggering, deploying, initializing, or otherwise integrating smart contract code into a data-driven contract or clause, by calling smart contract code that exists on distributed ledgers/blockchains (e.g., as part of an ‘on-chain’ library of scripts, being deployed or invoked at execution of the contract, etc.) and passing parameters to those scripts, by compiling logic to the virtual machine byte code of one or more distributed ledger(s)/blockchain(s), interacting with the application binary interface of distributed ledgers/blockchain systems (e.g., ‘on-chain’ contract code), by passing data/objects/arguments/functions/messages/parameters (or another entity) to on-chain smart contract scripts/code, through use of a blockchain/distributed ledger (BDL) API, and/or performing other suitable interactions. Programmable clauses in contracts may be on-chain and/or off-chain. A data-driven contract may therefore take a hybrid form. Herein, BDL is used to refer to distributed ledger systems and/or more specific consensus-based blockchain solutions, wherein any suitable variation of such systems may be used. References to BDL systems, platforms, integrations, transactions and the like could be distributed ledger variations or blockchain variations. Centralized BDL implementations, cryptographic databases, and/or other suitable systems with BDL-like features may additionally or alternatively be used in a similar manner as the BDL components.

Contracts embody and govern the relationships between an entity and external entities (e.g. suppliers, employees, financiers, outsourced service providers, etc.). As such, contracts are integral components of corporate organization/planning, governance, and commerce. Currently, such contracts are managed in a manner largely separate from other enterprise data. Thus current contracts are liable to create a disconnect between internal data and external relationships. For example, internal data may be used by enterprises to inform business decision-making, but contractual data is typically limited to the initial arrangement of the contract (e.g., the static state of contract at legal execution).

The system and method enables contracts and contractual relationships to be analyzed using data from a variety of sources, including (but not limited to): (a) the Internet of Things (e.g. network connected devices, edge computing devices, sensors, RFID, BLE and NFC chips, and any other such devices and data sources); (b) APIs (e.g. web services); (c) distributed ledgers/blockchains (e.g. transactions and other data stored thereon) and databases; (d) analytics services; (e) business rules systems; (f) enterprise management systems such as (but not limited to) Enterprise Resource Planning, Inventory Management, Customer Relationship Management, Contract Lifecycle Management systems; and (g) external documentation, and other data resources. The disclosed system and method enables data from contracts and other documentation capable of using or otherwise responding to data, to be analyzed both independently and in an enterprise context.

In addition, the system and method enables analysis of meta-contract and their contractual relationships, i.e. a body of contracts that together have a higher level of function than a single contract, i.e. a contract corpus. A corpus of contracts itself can create an enterprise state that can benefit from monitoring and analysis. The system and method provides such provides business intelligence and insight.

The system and method preferably operate by using data from a contract or a corpus of contracts, and any additional information from external sources pertaining to the contracts, to determine the contract state. The state of the contract may be provided in a number of ways. If the contract is at least partially computable, the contract state may be determined from the stored state of the contract itself, data relating to the contract, or from any state that is referenced by the contract. For examples, the state of smart contracts and transactions that have occurred on blockchains/distributed ledgers that pertain to the contract may be determined in this manner. For natural language (NL) contracts, where the contract is at least partially expressed in natural language, Natural Language Processing (NLP) techniques may be used to determine the state of the contract. Data may be contained in a contract (such as dates, prices, values, etc.) or may alternatively be stored external to the contract (such as the output of an IoT device, blockchain/distributed ledger, or APIs). Other forms of logic and other mechanisms may be used. Both computable and natural contracts may be used together in a given implementation.

As with computable and data-driven contracts generally, the system and method may be used in numerous different applications including (but not limited to): supply/sales agreements, trade finance, insurance contracts, employment/freelance agreements, maintenance agreements, service level agreements (SLAs), agricultural agreements, marketing contracts, property/land agreements, international, international trade, commerce, any combination of the above applications, and/ or many other alternatives.

The system and method provide a number of potential benefits. One such potential benefit is that data relating to contracts and business operations may be obtained and analyzed in real-time or near real-time. This arises from the ability of dynamic, real-time (or near real-time) contractual state to be determined and used in conjunction with data from other resources that provide enterprise and other data (e.g. financial markets data, ERP data, internal enterprise IoT data, etc.). Indicative examples may include (but are not limited to): contractual risk reduction/optimization, relationship optimization, selection of most appropriate suppliers based upon performance (e.g. timeliness, timeliness in certain prevailing conditions, etc.), which contractual provisions and certain effects e.g. reduced income/revenue the most (therefore providing a base to optimize against this in future contracts), what is the real-time effect of contractual performance on the state of an enterprise (e.g. are supply contracts optimized based on current Inventory Management System data, etc.). As such, the system and method enables contracts to be placed into or integrated more thoroughly within an enterprise context, rather than being segregated or treated separately from it.

Another potential benefit is that the system and method may be used to aid contractual and regulatory compliance. Given that the state of a contract (or part thereof) is known, the analytical capabilities of the system and method may be used to assess or otherwise aid assessment of compliance with both contractual obligations and other, external, regulatory obligations. As data pertaining to contractual state may be integrated with additional enterprise data, compliance, or projected/predicted compliance, with contractual obligations may be modeled, assessed, or determined. For example, the current state of a contract may be used to assess against performance of obligations in the same contract and/or other contracts (herein ‘linked’ contracts). One example of the latter may be a supply chain structure, where the state of one contract may be used along with enterprise data from other resources/systems to determine whether another contract may be fulfilled on time. Another potential example may be a subcontracting relationship, where the state of performance of one contract (e.g. where a party outsources the provision of goods/services to a third party provider) directly impacts the performance of another contract (e.g. between the outsourcing party and an end consumer of goods/services). In another potential example, data from contracts and other systems may be used, not related to the current state, but a future predicted or modeled state. Contract modeling and predictive analytics may be used based upon anticipated, predicted, or modeled events e.g. if a modeled/predicted event occurred (such as late delivery) what would the effect on contracts be (e.g. what penalties may ensue, which contracts would be validly terminable, etc.). The system and method may be used to predict/model events using the current contract state and/or enterprise state and/or external data (e.g. weather, currency exchange rates, etc.). Data collected by the system from either external resources or from natural language that is mapped in the aforementioned manner, may be used to learn a system model. The model can be subsequently used to predict contract status using the current contract state and/or enterprise state and/or external data (e.g. weather, currency exchange rates, etc.). By frequently assessing state, a dynamic assessment of risk modeling, optimization change(s), and other operations may be achieved throughout the contract execution process.

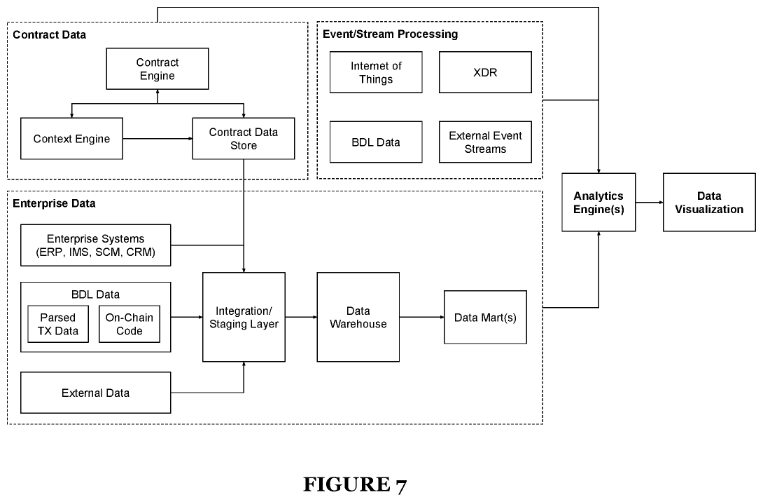

Yet another potential benefit is that the state of a contract or corpus of contracts may be used in conjunction with internal enterprise data (and any pertinent external data) to make informed contract-oriented (or other commercial) decisions as shown in FIG. 7. For example, inventory data (e.g. from IMS systems) may be used with contract state data to model the exercise of termination rights in a given contract. Questions such as: “Would termination still enable existing obligations to be met based current stock levels and the rate of sales/stock depletion?”; “Would the same be true when included with projected future obligations?”; “What would the knock on effect be for stock levels or other contracts?”; “Would other contracts suffer penalties due to failure to supply?”; etc. Thus deterministic complex mathematical questions may be answered efficiently using analytical modeling from the state of one or more contracts. The system and method enables contracting parties to analytically model the effect the state of a given contract or corpus of contracts will have on an enterprise. The system and method may be used to calculate the actions to be taken based upon the state of enterprise data (including existing contract state), and their projected implications. Additionally, the system and method may be used to automate perform the most appropriate automatically by the system (e.g. through use of a business rules engine, workflow engine, or other appropriate mechanism) and method or through manual user intervention. Machine learning and other techniques may be used to assist in the performance of automated operations, or to otherwise suggest appropriate operations/courses of actions to be taken based upon the state of contracts and enterprise data.

Another potential benefit of the system and method is that the state of contracts, either contextualized with respect to enterprise or other external data, may be visualized through data visualization methods (e.g. analytics/metrics dashboards, graphs, tables, charts, feeds, heat maps, etc.). This has the potential benefit of enabling users of the system and method to easily assess the current and, where used in conjunction with other enterprise data, the contextualized state of one or more contracts. Users may therefore be able to identify discrete issues, trends, optimization points, and other benefits or hindrances not directly obvious to the user. This may apply across a corpus of contracts, including active and/or past contracts, and/ or throughout the lifecycle of a single contract.

As the system and method may track the executed state/performance of a contract over time, the data may be used to track and analyze changes to the state of contracts and their performance. This may have the potential benefit of enabling the history of a contract and/or corpus of contracts to be analyzed. In one embodiment, the system and method may be used with contract systems that store not only the state of a contract in the execution phase, but also the state of the contract in the ‘formation’ phase (i.e. prior to the contract being executed). This history of a contract may be used to provide formation/negotiation analytics e.g. which contractual terms are most negotiated, most changed, what changes occur and how they occur, under what circumstances are certain provisions most heavily negotiated, what changes occur with certain suppliers, negotiation elasticity, etc.

A further potential benefit is that diagnostic, simulation, and/or predictive analytics may be used to identify and determine potential issues across a corpus of contracts. To reprise an above mentioned example, a supply contract may be analyzed in real-time along with IMS, SCM, and other data to flag potential supply shortages and actions to take (e.g. if delivery under an ‘in-bound’ supply contract is delayed, then which order should ‘outbound’ supply contracts be fulfilled to prioritize to minimize any penalties etc.). The same may be applied to insurance underwriting contracts (e.g. to assess real-time exposure)—particularly where real-time data from insured assets may be available (e.g. autonomous or connected automobiles, “smart buildings’ that use IoT/network-connected sensors and edge computing devices, etc.). This may be applicable both during contractual execution, as well as in the formation stage (e.g. using acquired data from previously executed and/or current contracts to optimize terms and conditions of new/subsequent contracts). Use of such data may be contextualized for a given contract to improve optimization, e.g. taking into account the nature of the contract itself, its subject matter and characteristics (such as building location, size, occupancy rate, etc.).

Data pertaining to the state of contracts along with other enterprise data may be used to model or predictively analyze the future state of a contract or corpus of contracts. For example, enterprise level data may be used in conjunction with the existing executed state of a contract or group of contracts to model potential future states of the same contracts and/or the effect on other contracts and the enterprise based on certain events occurring or certain permutations/scenarios (e.g. if the contracts are executed in accordance with their terms; if certain reaches occur, such as delayed deliveries). This may be particularly useful to model financial and operational implications.

Yet another potential benefit is that the system and method enables data that relates to a contract to be aggregated and analyzed. For example, supply chain data stored and/or financial transaction data on blockchain/distributed ledger, inventory data, and sales contract state may be combined together to provide contextualized and more valuable analysis as to: (a) contractual state; and (b) enterprise data (e.g. average cost, anticipated delivery date). The same may apply to a series of contracts—whether related (e.g. pertaining to a supply chain, subcontracting arrangements, a project, etc.), unrelated, or otherwise.

In particular for BDL related data, ‘smart contracts’ have the potential to automate operations in business processes and of an agreement. A potential benefit of the system and method is to extend that to use state beyond a given contract (e.g. between contracts, with external systems, to enable real-time contract state to form part of business analytics and intelligence).

Yet another potential benefit is that the system and method can enable the synthesis and automatic detection of relationships between contracts even if an existing relationship is not previously known. In some cases, relationships between contracts may not be detectable individually, however the system and method may facilitate understanding connections of contract related data between contracts and/or patterns indicating the relationships of different contracts.

### 2. System

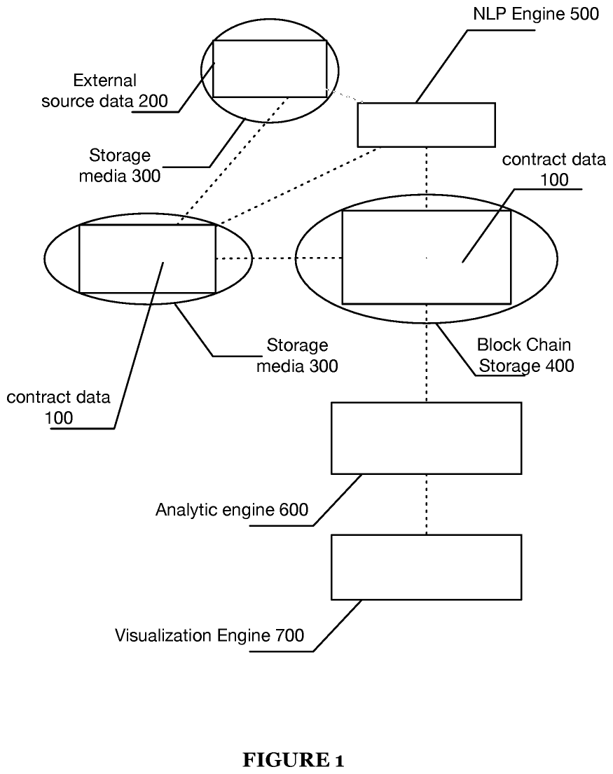

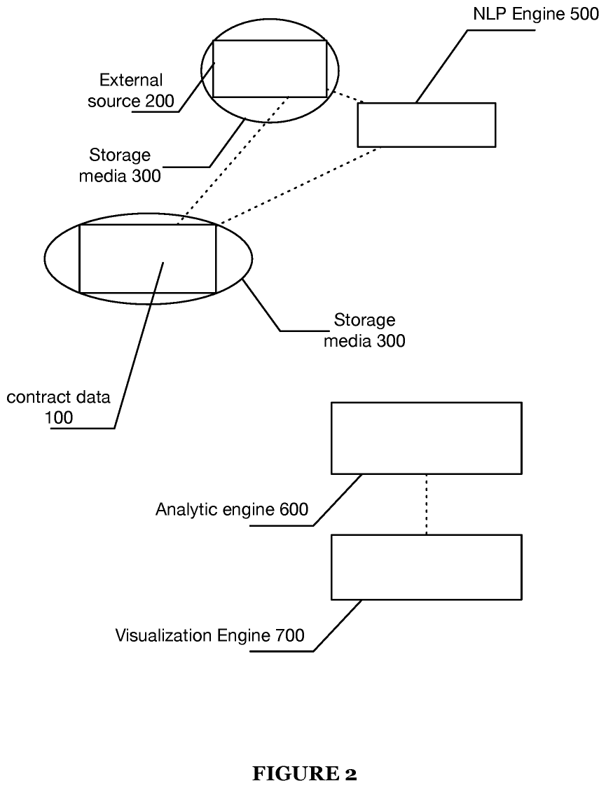

As shown in FIG. 1, a system for the dynamic, real time, analysis and management of data-driven contracts may include contract related data. The contract related data may exist wholly or partially within the data-driven contract as contract data 100. The data-driven contract's data 100 may include any appropriate data that pertains to the state and operation of the contract. Data may be acquired additionally from a multiplicity of sources that may interface with data-driven contract data 100 (e.g., a data input to a contract) or exist wholly external to the contract as external source data 200. One external source or one instantiation of an external source may both interface with the contract data 100 and provide external data 200. External source data may be stored on external source storage media 200. Storage media may include databases, blockchains/distributed ledgers, event stream processing systems, batch processing systems, APIs, web services, HTTP(S) clients, applications and systems (e.g. SCM, IMS, ERP, CRM and other systems), edge and network connected devices, Internet of Things platforms, and any other appropriate resource or services. External source storage data 200 may operate on an input/output basis with the data-driven contract data 100. External source data 200 may be stored separate from the data-driven contract data 100, which may be preferably stored in a distinct storage media 200. Preferably contract state is stored in a graph data structure (but may take any suitable form or combination of forms stored on various storage media 200 such as databases, file systems, distributed/peer-to-peer file systems, graph data structures, blockchains/distributed ledgers). Data pertaining to contract state (e.g., transactions, state objects, etc.) may also be stored on blockchains/distributed ledgers 400; passed there from other media storing contract data 100. Data from contracts may also be created by use of Natural Language Processing (NLP) techniques. In a preferred embodiment, a NLP engine 500 may be used to generate data from natural language contracts or clauses comprised of natural language in contracts (e.g. clauses, parts of clauses). The NLP engine 500 may enable natural language content in contracts to be analyzed by external sources by converting natural language provisions to computable form and then analyzed against aggregated and stored data. Stored external data 200 and data from the contract 100 can then be passed to a variety of analytics engines 600. Data may be passed directly to the analytic engine 600 (FIG. 2), or may be aggregated and stored across a variety of resources (e.g. in a graph format, on a blockchain/distributed ledger prior to being sent to the analytic engine 600 (FIG. 1). The output of the analytic engine can then passed to data visualization engine 700 to display analytics results via GUI dashboards or other visualization means. As seen in FIG. 2, alternatively and where appropriate, data may be passed from the contract to analytics engines 600 and data visualization engine 700 directly.

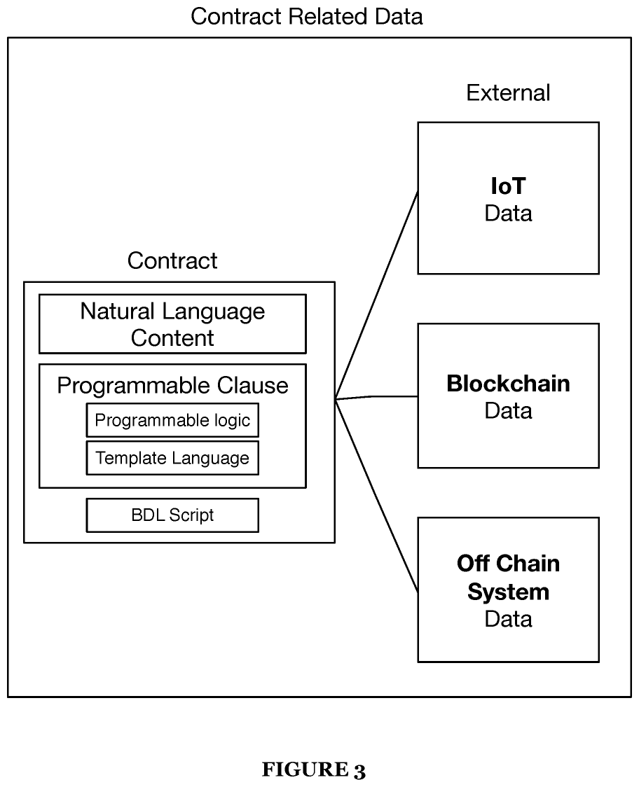

The contract data 100 of a preferred embodiment is a component of the system. The contract data 100 functions as the body of the data-driven contract between enterprises. The contract data may comprise of natural language clauses and content, essentially written text, and programmable clauses, machine-readable programmable components. The contract data may be the primary and/ or the only source of contract related data, but alternatively contract related data may be wholly or partially located in external sources that are then linked (e.g. through programmable clauses within the contract) to the external source data 200. External source data 200 may comprise of natural language clauses, programmable components, or any alternative form of data that may be accessible to the contract (including other contracts). FIG. 3 is a schematic example describing an exemplary hierarchy of contract related data. Contract related data is comprised of contract data 100 and external source data 200. Within the contract, contract related data may be in natural language or programmable clauses. External sources, such as IoT, a BDL, and some off-chain system may contain contract related data. Alternate external sources and/or alternate, or additional, forms of contract related data may also be examples of the system.

External sources preferably comprise of storage media 300 accessible to the contract that contain contract related data, i.e. external source data 200. Access to an external source may be direct or indirect access. Examples of storage media 300 include: databases, BDLs, event stream processing systems, batch processing systems, APIs, web services, HTTP(S) clients, applications and systems (e.g. SCM, IMS, ERP, CRM and other systems), edge and network connected devices, Internet of Things platforms, and any other appropriate resource or services. Storage media 300 may also contain contract data 100. The storage media 300 that contains the contract data 100 and external source data 200 may be the same, but may be a distinct storage media, or even a distinct type of storage media. A storage media 300 (either a previous storage media or a new one) may additionally store new copies, new versions, and/or alterations of the contract relate data. Stored data may be represented in, or otherwise make use of, cryptographic data structures such as Merkle trees, Merkle directed acyclic graphs, cryptographic file systems and databases, and/or other suitable data structures.

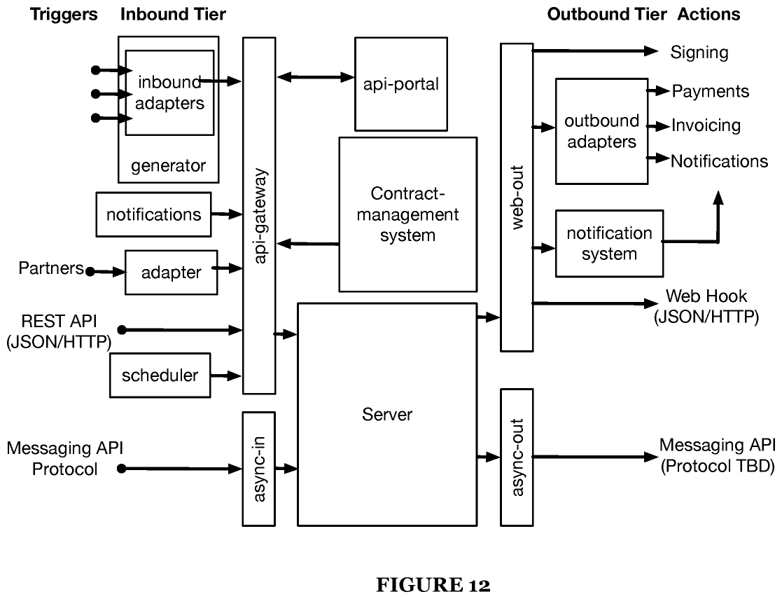

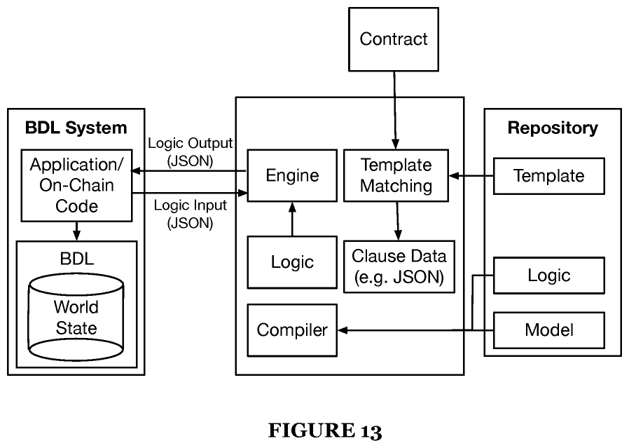

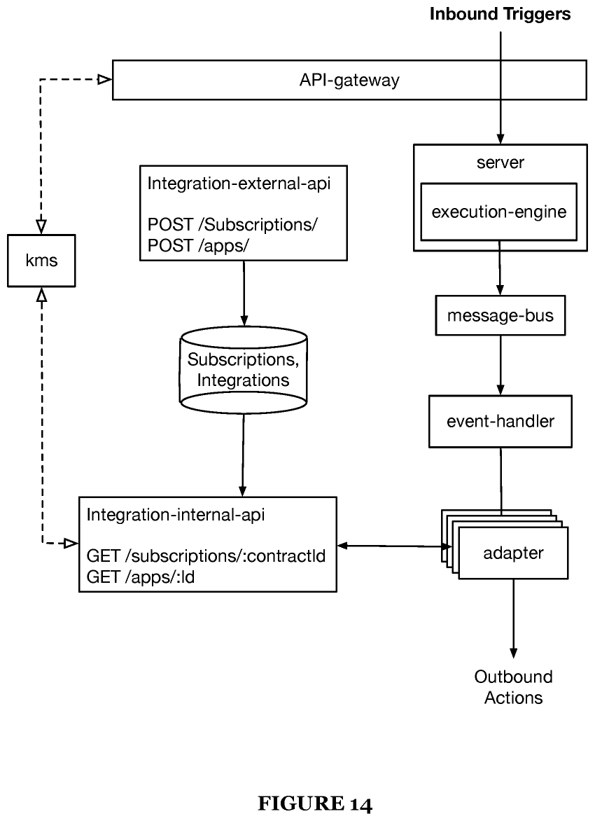

As described herein, a programmable clause within a contract may utilize input data from resources (e.g., APIs, BDLs, IoT/network-connected devices, databases, applications, systems, BDL system ‘oracles’, etc.), and may output data to resources (e.g., APIs, BDLs, IoT/network-connected devices, databases, systems, applications, etc.). In one example, data may be input from, or output to, an event log. FIG. 12 provides an exemplary integration architecture in which a contract is executed using a server-based runtime. FIG. 13 provides an exemplary server architecture. A server architecture may be run in, or as part of, any appropriate architecture. Alternatively, a peer-to-peer architecture or other suitable architecture may be used. FIG. 14 provides a depiction of an exemplary outbound integration architecture. Data may be output to any suitable external resource to perform any arbitrary operation (e.g., a fiat payment through an integrated transaction processing system, performing an action on an accounting system via API to raise an invoice, etc.) and preferably can be used as contract related data within the system. Inbound and outbound operations may use any appropriate messaging, communication, or other protocol (e.g., MQTT, AMQP, TLS, HTTP, HTTPS, websockets, etc.).

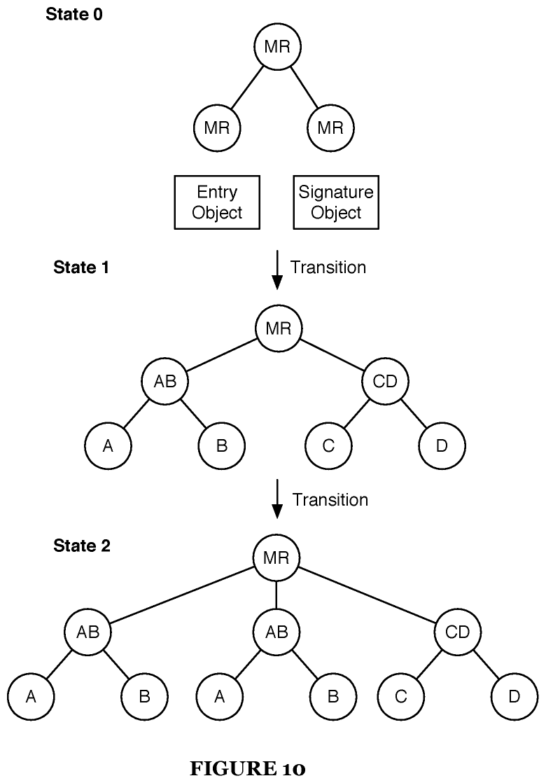

In one variation, a Merkle tree may be used in representing the state of a programmable clause and thereby a contract as shown in FIG. 10, In one implementation, the state of a programmable clause of a data-driven contract can be computed and output to a log. Operations on the log may include additions or deletions. Each operation is appended to the log to provide an auditable lifecycle of the contract execution. Where so used, the log may also include operations that occur not only in the post-formation execution phase of a contract lifecycle, but also in the pre-formation phase. For example, changes to programmable logic, natural language text (e.g., non-programmable clause), templates, models, and any other contract-related content and metadata may be added to the log. The log is preferably structured as a Merkle tree but other suitable data structures may alternatively be used such as a Merkle Directed Acyclic Graph of objects. Each new log entry results in a new Merkle root hash that represents the current state of the contract lifecycle (i.e., the aggregate of all entries in the log). Objects added to the data structure may represent any data about the state of the contract. FIG. 10 provides an example in which two objects are added in each entry (e.g., an object referencing the log entry and an object referencing the party signatures for that object). The system and method may be used with any arbitrary data.

The data structure may be stateful or stateless, and may be stored in any suitable storage infrastructure (e.g., database, graph database, datastore, relational database, etc.). In one particular embodiment, the data structure may be stored as objects in a decentralized or distributed file system (e.g. Interplanetary File System, etc.) or content delivery network.

A programmable clause may be a component of the contract data 100. Specifically, a programmable clause may be a component of a data-driven contract that at least partially defines dynamic operations of a data-driven contract and additionally may service as legal contractual clauses. Programmable clauses preferably include some programmable logic, which can be formed, expressed, programmed, written, or otherwise configured for using various programming paradigms or languages. A programmable clause may be substantially similar to the programmable clauses described in U.S. patent application Ser. No. 15/476,791 incorporated above. In some variations, one programmable clause can serve as external data 200 to another programmable clause, even across different contracts.

Natural language (NL) may be a component of the contract data 100 and/or external data 200. The NL component functions as text of the contract or contract related text. This is the text of a potentially binding contract, including all the details, e.g. stipulations, terms, etc., that may be considered necessary. Necessary details of the natural language component may vary from region to region, and may also differ due to the topic of the contract. NL may be in English, or any other spoken language, but may alternatively be in a coded language, encrypted form, machine language, or any other alternative form of “natural language” that can convey information. Although NL may be a component of contract related data, NL may not be directly accessible for the system and natural language processing (NLP) techniques may be required to implement NL contract data.

The NLP engine 500 of a preferred embodiment is a component of the system. The NLP functions as a “translator” that generates readable machine language (ML) clauses from NL clauses located in the contract data 100 and external sources 200. Newly generated ML clauses or content may be reincorporated and stored back at their source or used to generate a new aggregated contract related data. Alternatively NLP engine 500 may function “on-the-fly”, generating ML clauses as necessary and directly sending the clauses to the analytic engine 600. In one example, FIG. 1, the NLP engine 500 generates contract related data that is stored as contract related data.

In some embodiments, the system and method may only analyze data-driven elements of a contract or contract corpus. For example, the pricing.

In one embodiment, where natural language contract elements (e.g. entire natural language contracts or natural language clauses or parts of clauses in a ‘hybrid’ contract) are at issue, a rules engine (or other appropriate engine, module, system, or similar) maybe used to translate the outputs of the natural language processing stage into business rules that are then used to query in-bound data to provide contractual state. This contractual state may then be used in the same manner as contractual state provided by natively computable contract contracts and clauses. The business rule generation process may be performed by any appropriate method or combination of methods, including (but not limited to): Semantic Business Vocabulary and Rules (SBVR) or similar, generating business rules from the NLP engine output (e.g. a domain specific query language), or any other appropriate mechanism.

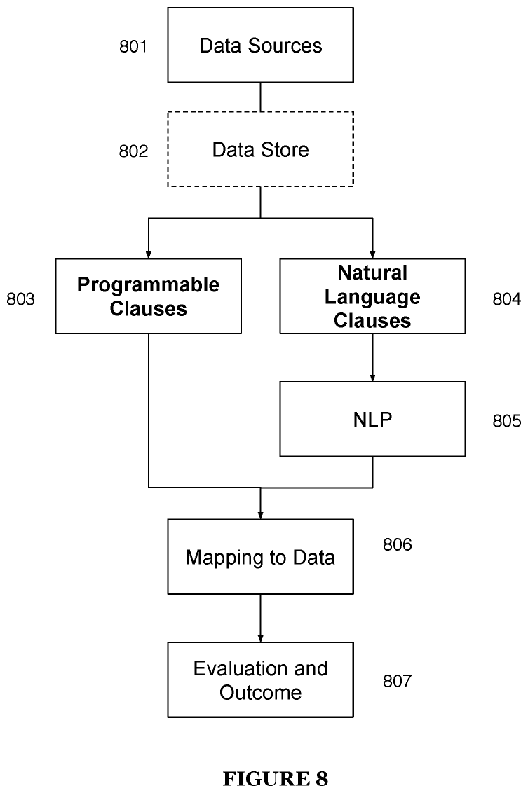

FIG. 8 depicts a high-level overview variation of the system in which data is acquired (801), stored (802), and then processed (803-807). The processing mechanism depends upon at least two major factors: (a) the nature of the data, such as whether the data is real-time/near real-time (stream processed) or not (batch processed); and (b) the nature of the clause(s) in the contract to which the data pertains to. With respect to the latter, the clause(s) may be computable, natural language, or a combination of the two. Where a computable component exists, data may be directly exposed to the clause(s) and evaluated in real-time or near real-time, or, alternatively, data may be stored and subsequently evaluated/analyzed, or, a combination of both may be used (e.g. a Lambda architecture or other appropriate architecture/structure). Where a natural language component exists, a NLP engine 500 may “convert” the natural language into programmable logic, queries, code, or other appropriate programmable component, using NLP techniques, and stores the “convert”. The same process may then be used for computable components using the computable clause representation so formed.

The analytic engine 600 of a preferred embodiment is a component of the system. The analytic engine functions to generate an analysis of the contract related data, giving a historic analysis of the contract to the present time, analysis of the current state of the contract, and modeling to predict future states of the contract. Analyzing contract related data occurs as a real time process. As external source data 200 and contract data 100 may change, contract analysis may change to reflect new information accordingly.

The visualization engine 700 of a preferred embodiment is a component of the system.

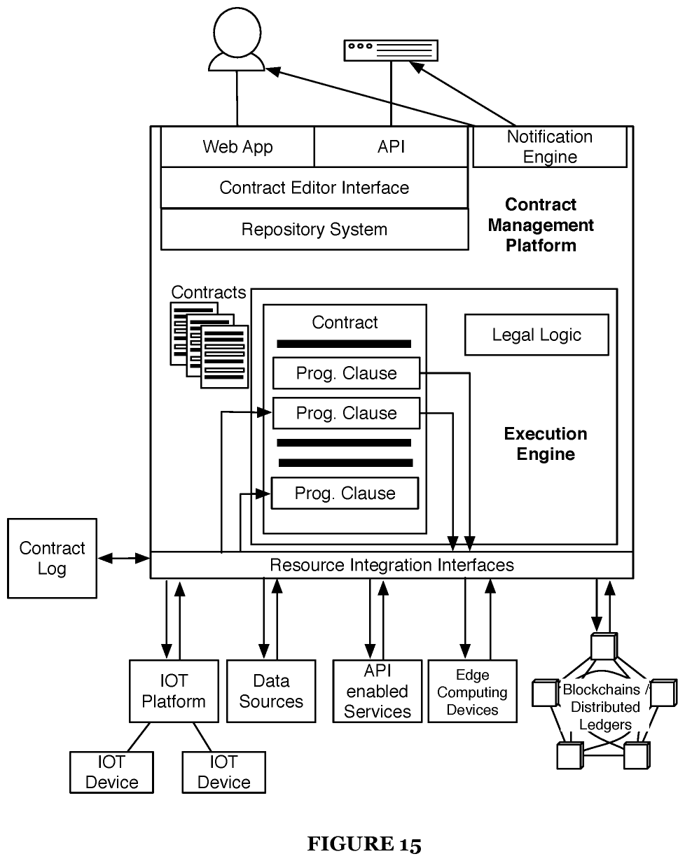

The visualization engine 700 functions to report data, predictions, and recommendations about the contract or corpus of contracts. Data presented may preferably include state value of the contract and any other current contract related data regarding the contract. In addition, the visualization engine 700 may present all analysis information that is known about the contract or corpus. Data presented may be literally presented visually in entirety, over a user interface, but may additionally or alternatively present or communicate data to an automated system that may be managing the contract. A variety of different forms of reporting and data visualization may be used in any given embodiment, including (but not limited to): information graphics, statistical models, descriptive statistics, inferential statistics, tabular data, and other forms. At least some of the data visualization is preferably interactive; enabling a user to modify visualizations. In a preferred embodiment, a data visualization application forms a component of a multi-tenant cloud-based platform. Alternatively, it may (in whole or part) take the form of a decentralized application, server-less, or distributed (e.g. on Interplanetary File System or other protocol) contract management platform. The contract management platform preferably enables users to manage the entire contract management lifecycle from drafting and negotiation through to management, renewal, and analysis as shown in FIG. 15. The contract management platform is preferably accessible by permissioned user access. Data may be accessible via desktop-based applications, API, smartphone applications, or other appropriate means. Data may be exported to other systems or applications and/or reports (either static or dynamic) may be produced. In a preferred embodiment, the of data visualization may be comprise of (but are not limited to): contract dashboards, aggregate dashboards, display feeds, notification engine, graph visualizations, blockchain/distributed ledger specific parser display, transaction and event (e.g. on-chain transactions performed by or pertaining a data-driven contract) feeds, data aggregated from external sources linked to a contract or corpus of contracts, “live”-stats, embedded indicators/ icons, and/ or suggestions. Other data types, forms, and subjects may be used in a given implementation. All, any, or none of the above may be used in a given embodiment, and may be used in conjunction with other forms, types, techniques, methods/mechanisms, and sources of data visualization.

### 3. Method

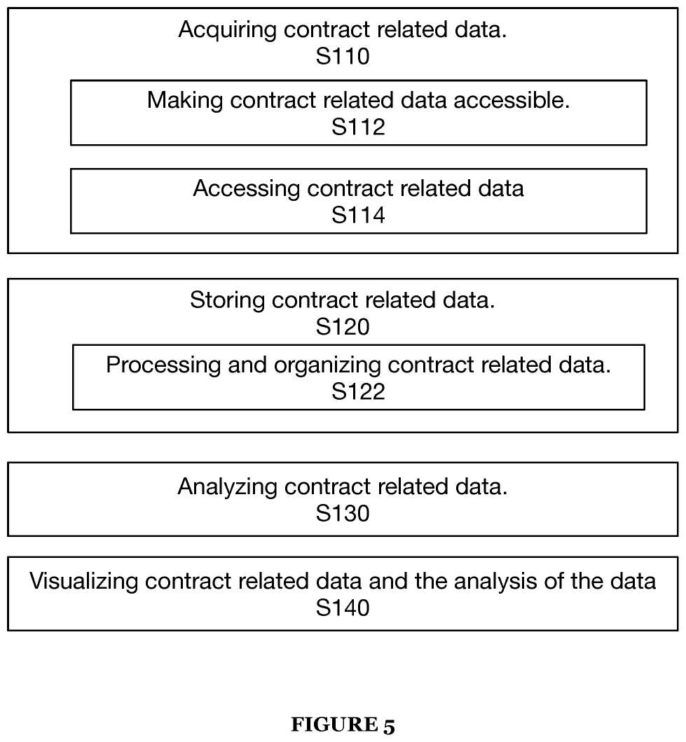

As shown in FIG. 5, a method of a preferred embodiment for the dynamic, real time, analyzing and managing of data-driven contracts can include: acquiring the contract related data S110, which may comprise of making contract related data accessible S112 and accessing the contract related data S114; storing the data S120, which may comprise of processing and organizing the data S122; analyzing the data S130; and visualizing the contracted related data and the analysis of the data S140. The method may be applied to data-driven contracts; contracts that comprise of at least one programmable component. A programmable component is a section that can be expressed wholly or partially in computer code. The programmable component will preferably be a programmable clause, but may alternatively be any other type of programmable component. Alternatively, or additionally, the method may be applied in part to static natural language contracts that are made accessible to this method by electronic means, such as scanned documents. In some variations, the contract corpus comprises of data-driven contracts and static natural language contracts.

### Contract Related Data

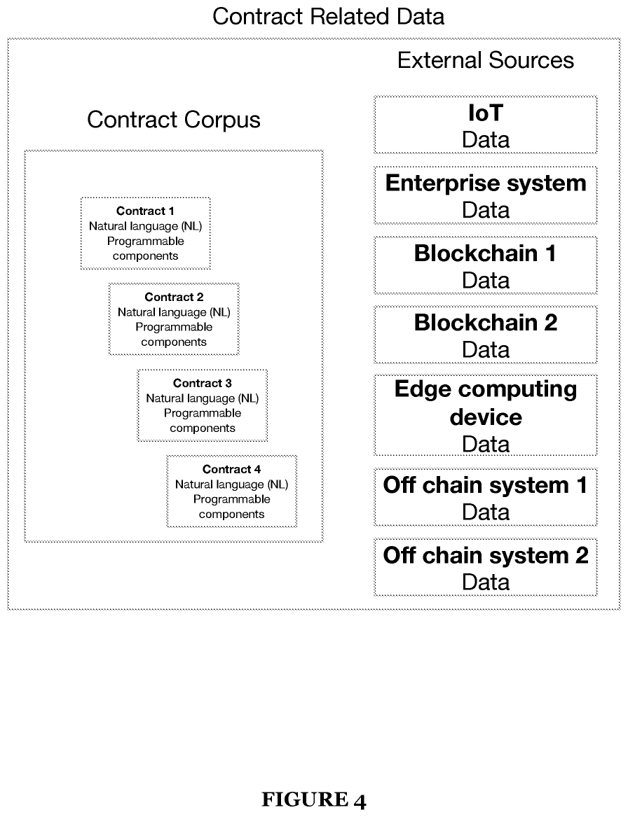

In a preferred variation, the method can be applied to a collection of contracts. That is, the method may be preferably implemented for analysis and management of a contract corpus. A contract corpus characterizes a body of contracts that may function together in some complementary, or overlapping, fashion to describe higher-level functions. FIG. 4 demonstrates contract related hierarchy, wherein the contract corpus comprises of the contract data within all the contract related data. In one variation, the contract corpus could include a single data-driven contract. A contract corpus may comprise a number of contracts. For example, a contract corpus could be created for all the plots of land in a region. Analyzing and managing this contract corpus may further comprise of analyzing the higher function of the general price of land in that region. Additionally or alternately, a different contract corpus may be created to describe the total value of everything on the first plot of land. In addition to the contract for the price of the land, this contract corpus may include all construction transactions (e.g. for new buildings) for this plot. A contract corpus may additionally include a plurality of types of contracts that relate to each other. In a car production example, a contract corpus may include a number of related contracts that describe the total profits for a company that produces cars. The contract corpus may include contracts for production side of automobile building (e.g. contracts to acquire raw materials to build cars, contracts with subcontractors that build or provide specific components, contracts for facility costs and worker costs), car marketplace contracts (e.g., car dealership contracts), and sale contracts dealing with sales contracts for each automobile. In addition to the contracts, the contract corpus for this example could further include all contract related data, such as current market car price and material costs, tax rates, and the like. This method can thus be used to analyze and manage higher-level function “meta-contracts”, contract corpus. All the contracts for the automobile company may be analyzed and managed individually, as described previously, or may be analyzed and managed as a contract corpus for the net profit of the company.

The method may also utilize the state of contractual agreements in conjunction with data from the other sources to analyze the contextualized state of a contract or contract corpus. Contract related data will thus refer to all internal contract, or internal contract corpus, information in conjunction with data from other sources used to analyze the contract or contract corpus. The contextualized state of a contract may be seen as setting the contract within its context (e.g. enterprise, physical world, etc.), as determined by data that represent the state of an enterprise, the physical world, or other appropriate context in which a contract or contract corpus exist. For example, the real-time or near real-time state of a supply/sales contract may be used alongside internal enterprise data (e.g. ERP and IMS data) and external data (e.g. weather, financial exchange rates/prices, etc.) that provide the context within which the contract operates within; both in respect of the internal state of the enterprise of the user, and the physical world.

### Acquiring Contract Related Data

Block S110, which includes acquiring contract related data, functions in identifying and gathering information that may be of interest and/ or necessary in analyzing and managing a contract. Acquiring contract related data includes making contract related data accessible S112, and accessing contract related data S114. Contract related data comprises of information within a contract in addition to any additional contract related information. Additional information can be of any type that is accessible to the system and useful and/or necessary for analysis of the contract. Examples of related data include (but are not limited to): weather data for shipping contracts, market housing prices for real-estate contracts, financial markets data for insurance and financial contracts/instruments, tax rates and trends for sales contracts, data from complementary related contracts for complex sales arrangements, the state and terms for similar contracts, etc. Contract related data may additionally change, increase, or decrease, as deemed necessary. Data is acquired from sources that may include (but are not limited to): contract data (e.g. stored on databases, BDLs, etc.), IoT platforms, edge computing and network connected devices, ERP/SCM/CRM/IMS and other Enterprise systems, data from blockchain/distributed ledger oracles, data stores (e.g. databases), complex event processing (CEP) and event stream processing (ESP) systems, analytics (e.g. data processing systems) and cognitive computing services, applications, and web services and other systems via APIs.

Block S112, which includes making contract related data accessible to programmable clauses within the system, functions to make data “readable” for use. Programmable components (e.g. programmable clauses within the contract or elsewhere) may be directly exposed to programmable components within the system, and thus already accessible. Alternatively, programmable components may not be directly accessible and a compiler or parser may be required to translate programmable components for use. Natural language (NL) components of contract related data may also not be directly accessible. Making contract related data accessible to programmable clauses within the system S112, may additionally comprise of making NL components accessible.

### Acquiring External Source Data

Acquiring contract related data S110, may further include acquiring contract data from external sources as mentioned above. External sources may include data on BDLs, IoT, enterprise systems, off-chain systems, or any alternative data source that has relevant contract related information and may be made accessible. Making contract related data from external sources accessible S112, e.g. a blockchain ledger, may involve parsing, listening for, and/or extracting data via an API or other appropriate method.

Resources, contract related data external to the contract that may be involved in execution of the data-driven contract, may function as machine-readable inputs. Data from a variety of resources may be used in the execution of data-driven contracts by exposing data to the logic of contractual clauses directly (e.g. from a defined resource such as a network connected device, API, etc.) or indirectly (e.g. via. CEP/ESP engines, IoT platforms, API gateways, etc.). Resources may fall into at least three categories: data concerning the state of the physical world, data from enterprise systems, and internal systems. Data concerning the state of the physical world is a type of resource data. Physical world data is data gathered from a broad set of sources that include data gathered from: Internet of things (IoT), network connected and edge computing devices. Examples of edge computing devices include: sensors, actuators, robotics, connected vehicular devices, wearables, UAVs/drones, smart materials, and many others. Such devices may be used for various applications, including (but not limited to): industrial, agricultural, automotive/transportation, energy, healthcare, “smart cities”, retail, supply chain, and many more. In addition, data may also be provided via or aggregated, analyzed, from IoT platforms, event stores, BDLs, event stream processing and batch processing systems, and any other system upon which such data is processing and batch processing systems, applications, web services, transaction systems, and any other system upon which such data is processing and/or stored. Physical world data may also include data concerning intangible physical world events (e.g. currency exchange rates, commodity prices, financial information, etc.) Data from enterprise systems, may also be a type of resource data. These data may comprise of data gathered from enterprise systems such as: ERP, IMS, CRM, SCM, and web-based services. Examples of enterprise web-based services include accounting/invoicing systems, payment systems, and APIs to BDLs, to platforms, to systems, and to applications. Internal systems may also be a type of resource data. These data include data stored in semi-isolated internal systems and databases. Examples of internal systems may include: transactional databases, operational databases, data warehouses, data lakes, file systems, or files. Data may be queried directly from source or aggregated in a cloud or other data storage medium.

### Acquiring Contract Data

Contract data may include programmable clauses and natural language clauses. Data from and relating to contracts may be obtained in a number of different ways; either from natural language contracts, machine-readable (‘computable contracts’), or hybrid contracts that exhibit features of both (e.g. a contract comprised of clauses in computer code and natural language and/or code that executes aspects of contractual performance e.g. “smart contract” code on a BDL). As such, data may relate to natural language prose or machine-readable provisions of a contract. The latter may involve data from the contract (e.g. from a clause or otherwise) being output from the logic and stored in the aforementioned media. Other structures may be used where appropriate. The former may be mapped through use of Natural Language Processing (NLP) and Machine Learning (ML) techniques to a machine-readable provisions. That is, accessing contract related data S122 may comprise of NLP and ML techniques.

### Acquiring Natural Language Clauses

Where the contract is expressed, wholly or partially, in natural language, accessing contract related data S122 may comprise of using a NL process to assess the natural language components of contracts. Not all natural language clauses/content may be ‘converted’ modeled in this way.

The NL process preferably has the following three main stages: (a) feature generation; (b) feature reduction; and (c) model learning. Once the model has been learned, it may be used to predict the mapping of natural language clauses into machine-readable versions. That is, machine learning, through the NL process may improve in assessing NL clauses and predict appropriate machine-readable versions. In a preferred embodiment, the method will collect a library of typical natural language clauses with their machine-readable equivalents. A number of variations for each clause may be used to enable varying degrees of component granularity to analyze natural language contracts, i.e. the additional variations may occur at the ‘part-clause’, ‘clause’ level, ‘section’ level, or ‘contract’ level. The ‘part-clause’ level enables users to create machine-readable contract clauses from natural language using components that together comprise clauses (e.g. parts of contractual clauses or grammatical clause units). An advanced analysis of the natural language components will be performed to identify any data sources mentioned in the contract and how the language is used to incorporate them. Where no data or data sources/resources are mentioned, then method will use a mapping process to match natural language to appropriate data and resources. Data source identification will mostly utilize approaches such as bag of words and term lists. Extracting the conditions will utilize advanced analysis such as sentiment analysis and part of speech (POS) based feature generation and selection. In both cases, an array of models will be constructed using various algorithms. Machine learning can be defined as the algorithms that give computers the ability to learn without being explicitly programmed.

Classification is a subset of machine learning in which the focus is on learning how to classify a dataset. A wide variety of classifiers exists that range between general classifiers to domain-specific ones. Various classifiers that may be implemented, including (but not limited to) are: bagging, boosting, GLMNET, mas entropy, neural networks random forests, scaled linear discriminant analysis, and support vector machines. Bagging is generating multiple versions of a predictor and using these to get an aggregated predictor. If number of versions is more than one, bootstrap replicates of the learning set are generated and then used as new learning sets. Boosting is to aggregate a set of weak learners (classifiers that perform slightly better than random) to create a strong learner by weighting them appropriately. GLMNET is an implementation of the “Lasso and elastic net” regular generalized linear models. Maximum entropy is a probabilistic classifier that selects the model with maximum entropy from among a set of models and uses it to classify the data. Neural networks are used to approximate functions that can depend on a large number of inputs and are generally unknown. Weights are used to tune the relationship between the nodes of the neural networks based on experience, rendering the network capable of learning. Random forests selects the best performing from among multiple learning algorithms so as to improve predictions. In one embodiment, an ensemble of trees may be used, and then letting them vote for the most popular class. Scaled linear discriminant analysis expresses one dependent variable as a linear combination of other variables and assumes continuous independent variables and categorical dependent labels. Support vector machines divide the dataset via a set of hyperplanes, during the learning phase, and map the new data to fall behind one of the hyperplanes. One or more of the classifiers may be used together in any given implementation of the method.

Thus acquiring contract related data S120 for a NL system may comprise of making contract related data accessible S122 by learning each NL model and subsequently testing them against real data to assess each model's accuracy and F-Score. The models will preferably be used to construct the logic of the programmable clauses of the contract; thus effectively converting an natural language contract to a computable contract.

### Accessing Contract Related Data

Block S114, which includes accessing contract related data functions to set an explicit access to contract related components. Once components are accessed, they can be further stored and/or analyzed. Where the contract is expressed, wholly or partially, in machine-readable form, the state of a contract or part thereof may be determined by assessing programmable logic of a contract (e.g., code of a programmable clause in a data-driven contract), as well as the current state and past execution of the programmable logic. Machine-readable form may preferably be directly interfacing with the system and automatically accessible. Machine-readable contracts may be ‘data-driven’ in the sense that they are able to use data from external sources (e.g. to determine contractual performance and update contract state). Data may include updates provided to the contract by (and not limited to): contracting parties, third parties (e.g. entities that can provide data about the performance/non-performance of contractual terms and obligations), and external systems and resources (such as those mentioned above). For example, such data may be (or may be included in) messages that call functions in computable clauses. The data may be evaluated and functions executed. The input data, any changes to the state of the contract, events/operations perform internally to the contract (e.g. updates to other clauses) and externally (e.g. on other systems such as BDLs, accounting systems and payment systems via APIs) may then be stored (e.g. database, graph data structure) to be queried and used for analytics. Data may be represented in a Merkle or cryptographic data structure. In one variation, a Merkle tree can serve as a log of operations and state from a data-driven contract.

Accessing contract related data S114, with regards to NL clauses, and other non-machine readable clauses, may require prior modification as described for block S112, making contract related data accessible. In some variations, data obtained or extracted in NL clauses may be similarly stored and made accessible through the same or a similar data structure. For example, contract state can be represented within a Merkle tree as with the dynamic data of a programmable clause.

### Storing Contract Related Data

Block S120, storing contract related data functions to organize contract related data in an appropriate fashion for monitoring, management and analysis of the contract related data. Storing contract data includes processing and organizing contract related data S122. Storing data S120 may occur in at least three ways: Firstly, data may be exposed directly from their sources to the programmable clauses of each contract, wherein storing may not be required. Secondly, storing data may require aggregating and storing in a data storage mechanism (e.g. a database, series of databases, distributed databases, BDLs, data lakes, or any other suitable storage mechanisms) and then evaluated by the programmable clauses of the contracts. Thirdly, data may not be used by a contract, but may be applicable to the context in which the contract operates in or is otherwise related to (see ‘Context Engine’) or pertain to natural language contracts or contractual provisions; wherein this type of data may be involved in processing and organizing contract related data S122.

### Storage Location

Storing contract related data S120 pertaining to the state of a contract may occur in any suitable form or medium. For example, data input to and output from programmable clauses, operations performed by a programmable clause/contract on external systems, changes to the state of contracts, data output to and transactions performed on BDLs, and any other data that relates to the operation and execution of a contract may be stored in databases, data lakes, decentralized file storage, event stores, BDLs, or any other suitable medium and data structure. When storing contract related data S120 from multiple sources, or when it is necessary to aggregate data to one or more locations, a data warehouse, data lake, or similar, may be used as a central repository of integrated data. Data is preferably acquired and stored in a cloud-based, replicable, storage mechanism or mechanisms. Alternatively, a data center or other similar mechanism may be used. Multiple data storage mechanisms may be used in a given embodiment (e.g. one or more BDLs, databases, data lakes, etc.).

Storing contract related data S120 accessed from a BDL may include storing in a database, event store, data warehouse, decentralized file storage, data lake or other appropriate storage method. The data may be stored in a database structure and queried and/or queried directly from the original blockchains/distributed ledgers. Multiple BDLs may be used in a given implementation (e.g. one contract may use multiple BDLs of the same or different protocols). That data may then be used as an input by the analytics engine. BDL transactions (and other) data may be monitored using streaming analytics to provide blockchain/distributed ledger state.

Storing contract related data S120 may comprise of storing data about contractual state in databases (including cryptographic/BDL databases, real-time databases, graph databases, distributed databases, and others), BDLs (e.g. as on-chain/on-ledger code, transaction data, state, and other data such as associated IoT data, etc.). Other storage mediums and mechanisms may be used, and more than one medium may be used in a given embodiment. Storing data may involve more than one storage mechanism or medium and may be used for a given contract or across contractual relationships, i.e. a contract corpus. For example, one contract may consist of or be associated with: (a) data stored in a database about the contract state; (b) data stored on a BDL that are part of, or otherwise pertain to, the contract (e.g. objects/data instantiated on-chain such as records, transactions, etc.); and (c) data that is related to the contract but does not form part of the contract itself e.g. (to take a supply agreement as a working example, this may include: shipping data, trade finance documentation, invoices, purchase orders, packing lists, as well as inventory data etc.).

### Storing Using Graph Structure

In some preferable variations, storing contract related data S120 comprises of storing contract related data using a graph data structure or Merkle tree data structure. A graph preferably stores properties and transactions that pertain to a contract. A contract is represented through a series of objects: nodes and links/edges, which represent the relationships between those nodes. Preferably the forming of the graph data structure occurs concurrently to generating the contract logic (e.g. state of the contract logic and relationships between clauses). This may occur through adding standard form clauses and configuring relationships between those clauses and/or forming the logic using syntax and grammar using an IDE or similar development environment. Other mechanisms for creating contracts may alternately be used. As discussed, a Merkle tree data structure may be another variation that can be used in representation and access of contract state data.

The graph data structure may be used in storing the state of the contract as it executes. For example, the graph may store events and operations that occur under the contract logic as it interfaces with data from a variety of data sources (e.g. APIs, BDLs, IoT and device data, enterprise systems, external data feeds e.g. weather, foreign currency exchange rates, spot prices etc.), performs actions on external systems (such as updating accounting systems to reflect payments made under a contract or dynamic price changes on invoices), and performs transactions using on-chain/on-ledger code or other on-chain/on-ledger objects. In one example, data from an external resource may be processed and evaluated by a programmable clause and the result can be recorded in a graph data structure.

One or more graphs may be used. For example, separate graph may be used for each chain/ledger, or graphs may be combined to model relationships on each chain and then linkages between chains to model interoperability. In one implementation this could be a graph per contract or a series of linked contracts. By doing so, it may serve as an extension to a graph data structure that models a contract (e.g. by linking common or related objects between the graph data structures), where applicable. Furthermore, graph data structures may model links between off-chain/off-ledger data and on-chain/on-ledger data. One such example may be, off-chain/off-ledger computable (or hybrid) clauses in a contract that are linked to or otherwise use on-chain/on-ledger data as inputs, product outputs, invoke and/or deploy on-chain/on-ledger code or perform some other operation. Graph data structures enables the relationships between on-chain/on-ledger code and perform business and contractual processes may be mapped to the graph.

Storing contract related data S120 in a graph data structure may occur at the nodes of the graph. The nodes in the graph data structure can store any data about the state and operation of a contract or contract corpus, including (but not limited to): the machine-readable code of a contract, the structure of the contract, changes to the machine-readable code of a contract, events that occur under the contract caused by execution of the contract logic, external data inputs, and operations performed by the contract. The structure of the contract may include clauses, sub-clauses, sections, etc. Changes to the machine-readable code of a contract may be caused either through amendments to the code affected by the contracting parties in negotiation of the contract, post-execution amendments to the contract code, or changes to the executable code caused by the execution/operation of the contract logic. An example of an event that occurs under the contract caused by execution of the contract logic is a price change in a pricing clause resulting from a late delivery under a supply contract. Examples of external data inputs are inputs from APIs, and/or inputs from IoT devices. An example of an operation performed by the contract is execution of an operation on an external system, such as a payment, deployment/invocation/execution of a script on a BDL. Preferably a new node object is added for each operation, update, event etc. Each node is preferably linked to nodes representing previous states as well as to atomic objects on which it depends for input (and metadata relating to the change/new event), thereby providing a complete immutable chronological record of the state of a contract as it changes over time. Preferably the data structure is append only.

Metadata and properties may be stored relating to any objects in the graph data structure. An object may represent any data that corresponds to the contract logic (e.g. source code objects that comprise clauses, relationships between source code objects, amendments to code, etc.), contract state, execution, performance, transactions, objects representing internal and external operations, changes, updates, events, operations performed on external systems, and any other appropriate data. An object may represent data of any level of detail. For example, where in one implementation an object may represent a group of data; another implementation may represent the same data as a number of objects. Preferably all objects are atomic in nature. Entities may be comprised of or linked component objects. For example, a contractual clause may be comprised of a number of atomic objects that contain the programmable logic (code) and/or prose of the contractual clause and are represented in the graph data structure as a clause object and the component atomic objects. Other means of representation may be used. Example object data type include (but are not limited to): Code, represents the executable code of computable clauses/contracts; blob, represents natural language data as binary large objects; update, updates to the state of the contract by exposure to state update messages (e.g. such as a price change in a pricing clause as a result of a breach of a condition in another clause, termination by a contracting party etc.); commit, changes to the state of the contract logic by the parties before execution of the contract (e.g. a proposed modification by one party that is accepted by other parties in negotiation); amendment, changes to the state of the contract logic by the parties after execution of the contract (e.g. to reflect a change to the contractual agreement); transaction, operations performed on external systems, platforms, and protocols (e.g. transactions on blockchains/distributed ledgers, payments made on systems via API); and event, operations that occur that do not amount to a transaction (e.g. data added to blockchains/distributed ledgers, notifications sent, updates to data on external systems, etc.). Additional or alternative data objects and structures may be used in a given embodiment of the system and method.

In one embodiment, multiple graphs may be used per contract or group of linked contracts. For example, one graph structure may be used to store the ‘pre-formation’ state of the contract (i.e. versioning prior to the computation of the contract), and another may be used to store the state of the contract in the ‘post-formation’ stage (i.e. after the contract has been executed). In the latter instance, for example, data may pertain only to operations such as state changes and amendments.

Data may be stored externally to the data structure (e.g. in an external data store, decentralized file system, database, or similar) such that the data structure references that external data.

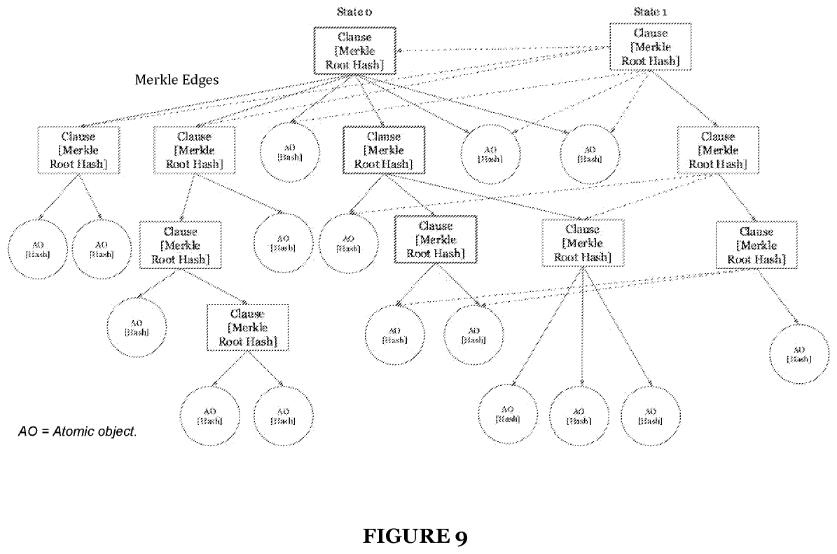

In some variations, storing contract related data in a graph data structure may comprise of storing or representing the state of a contract or series of linked contracts in a Directed Acyclic Graph (DAG) form in the graph data structure. A DAG will preferably have Merkle links between the objects, either to express relationships between objects in clauses (e.g. an object in one clause being referenced in another clause, such as price), and/or store data relating to objects, history of changes to objects, and the like as shown in FIG. 9. A Merkle edge/link is a cryptographic graph edge hash (e.g., SHA-3, SHA-256), referencing or otherwise, defining a relationship with another object and represented by the hash of the target object, and embedded in the source object. Other types of edges may alternatively be used. Any suitable form of relationship between objects may be represented (e.g. transactions, amendments, events, inputs, outputs, state updates, and many more). Each relationship type may have subtypes. For example, events may be further divided into contract events, such as termination and processing events.

### Processing Data for Storage

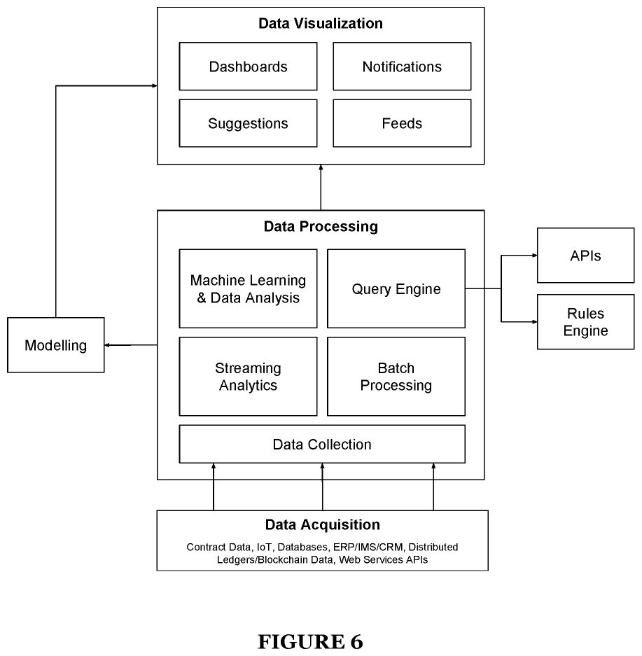

Block S122, which includes processing and organizing contract related data, is preferably part of storing contract related data S120. As shown in FIG. 6, processing of data preferably operates in coordination with data visualization. Processing and organizing contract related data S122 functions to setup and help optimize data to facilitate changing, monitoring, and analyzing contract related data. Organizing data may include aggregating/collating data, or copies of data, to one specific location for use but may alternately store links to the data locations. Collating data preferably uses streaming and batch data processing techniques to collect the data from different sources into a centralized, cloud based data storage system. In alternative variations, other storage systems may be used. The data is processed and used to trigger events. The event system will hydrate the models that provide the output for the analytics system. The data will preferably be replicated into a distributed multi-node configuration to accommodate performance and retrieval speed.

In one variation, processing and organizing data S122 comprises of aggregating and processing contract related data prior to that data being used by other components of the system. Depending on the implementation, if a graph structure already exists, aggregating and processing may only comprise of collating data that is not already stored in the other graph, for example when only metadata and/or hashes are stored in the graph. Collating contract related data may include on- and off-chain/ledger code and, data from databases and graphs, and external data relevant to a contract (e.g. IoT data, transaction data, etc.). Processing and organizing data S122 thus enables data that pertains to a contract or group of contracts to be collated and associated with one another in an appropriate manner. One preferable example of this variation may include processing and organizing data S122 for an entire contract corpus. Collating contract related data may additionally comprise of combining graphs of distinct contracts and thus creating new graphs with additional edges linking associated inter-contract relations.

In one example, a graph data structure of on-chain/on-ledger data may be used to model transaction relationships between on-chain/on-ledger data (e.g. BDL addresses/identifiers). Once the transaction records are obtained and/or extracted from the BDL(s) (acquiring the contract related data S110), storing the contract related data S120 is accomplished by processing and organizing the contract related data S122 into a graph structure (preferably DAG form), thus forming a directed graph from the transaction data and transaction related data. This data may include payments made between public addresses, data added by users, and relationships between accounts. The data may additionally, or alternatively, include any and all other relevant information. In the directed graph, the nodes may denote public addresses/identifiers of entities (such as users or other objects like shipments in supply chains etc.) and the directed edges may represent a particular transaction from a source address to a target address.

In some variations, the method may use a meta graph data structure, which may relate to an enterprise data structure. Processing and organizing data S122 into meta graph data structure potentially enables contextualized data concerning relationships between documentation (as well as data pertaining to those relationships that are capable of being linked). For example, invoices could be related documentation such as invoices linked to contracts, linked to purchase orders, linked to accounting/bookkeeping entries, SCM/IMS/ERP/CRM entries, distributed ledger/blockchain-based transactions, and the like to be identified. This may be used as the basis for operational organization/management, analytics, and other applications. In one embodiment, the meta graph data structure may be used to map and connect metadata references from these systems (e.g. contract references, purchase order to contract references, inventory/SKU, accounting entries, etc.). One or more BDLs or Distributed Hash Tables (DHTs) may be used for this purpose. Other methods may be used. Graph analysis may be performed to provide analytics and insights into the state of an enterprise through its contractual relationships. Secondly, details pertaining to persons (e.g. employees) that performed certain actions in respect of documentation may be logged as metadata to enable those persons to be notified of events/issues in respect of those documents. For example, an employee that executed a purchase order under a contract may be notified of events that occur in respect of that purchase order by virtue of data updates through a contract management platform in respect of that contract/purchase order (e.g. data added to the graph that are related to the purchase order). Notifications may occur through a notification engine or module of a contract management platform or other appropriate mechanism (e.g. via API to external resources providing notifications). Thirdly, data may be used for internal audits (regulatory, performance, risk management (ERM) etc.). One embodiment may use machine learning technologies to tag objects and data in the meta-graph data structure and/or to interpret a Merkle tree of contract related data.

A context engine may also be used to provide batch and/or real-time data pertaining to the enterprise and the context of the contract within the enterprise and external environment. Context, such as historical data relevant to the event, can be added to the materialized view. In some variations, the context engine may make use of a graph data structure to provide insight into, and context of, enterprise state. Graph data structures or other suitable data structures like a Merkle tree that store the state of each contract (as above) may be combined to: (a) map inter-contract relationships (i.e. between two or more contracts); and (b) provide a basis upon which enterprise data may be added and/or used to augment the graph data structure to place contractual relationships in context with other enterprise data. One such embodiment is the relationships between documentation (e.g. contracts, invoices, purchase orders, trade finance documentation, transactions, and other documentation) and data within those entities, may be formed. Additionally, other enterprise data (such as from enterprise systems, network-connected devices, APIs, etc.) may also be used in a graph. Multiple distinct graph data structures may be maintained and associated or connected across different contract graphs. Alternatively, a contract graph may represent two or more contracts. Examples of use of enterprise data may include (but are not limited to): a field in an invoice such as price, tax, tax rate, or net payment terms; a clause in a contract or a portion of a clause in a contract; a term or field in a purchase order; an item, document, record of enterprise data, or similar (e.g. ERP, CRM, SCM data); a transaction, reference, object, or script/code or other data on a BDL system, etc. Links may be between on-chain scripts/code that have been executed and/or due to be executed, hashes of invoices, hashes of purchase orders, and enterprise data (which may be extracted and stored as an object or series of objects). A content-addressed filesystem (e.g. Interplanetary File System (IPFS)) or similar may be used for this purpose. In a preferred embodiment, the graph data structure does not store the actual content of a document in the graph but metadata including the path to the document. In a preferred embodiment, such documents are at least partially expressed in machine-readable code. NLP techniques may be used to extract data objects from non-computable documentation, as aforementioned.

### Analyzing Contract Related Data

Block 130, analyzing contract related data, functions to generate an analysis of the contract, giving a historic analysis of the contract to the present time, analysis of the current state of the contract, and modeling to predict future states of the contract. In addition to the data within each contract, all related accessible information may be used for analysis. Analyzing contract data may occur as a real time process; as external data and contract data may change, contract analysis may change to reflect new information accordingly. As analysis may often be a computationally intensive process, data streamed through storage and graph storage configurations may additionally assist in data access to improve analysis times.

Analyzing contract related data S130 may further include analyzing a contract corpus. Analytics for a contract corpus may be carried out for each contract within the entire contract corpus independently, be carried out for the entire contract corpus, as one set, or may be carried out for groups of contracts within the contract corpus (e.g. defining multiple smaller contract corpuses). A contract corpus may be a series of unrelated contracts (e.g., unrelated in a transactional sense) that have a common interest or aspect. For example, a contract corpus could relate to inventory of goods in a supply chain. Contract related data from this contract corpus could be analyzed to report on inventory activity. Any other subdivision of the high level contract corpus may be alternatively implemented as an alternate contract corpus, and/or only a subset of contracts within the entire corpus may be analyzed as its own distinct contract corpus. In the complex world of analytics, implemented analytical techniques may be changed over the lifetime of contracts to take into account changes in the system that may make certain methods of analysis better suited to the information desired. Examples of reasons to change analytical techniques include when time step updates of the “real-time” analysis are not sufficiently small, or change in contract state causes the behavior of the contract to change significantly, making the current analytical technique ineffective.

Analyzing contract related data S130 types may support a variety of different analytic functionalities, including: (a) descriptive analytics; (b) diagnostic analytics; (c) predictive analytics; and/or (d) prescriptive analytics. Each of these analytic functionalities may be used independently, with another, or in any suitable combination. This data may be used for a variety of enterprise purposes, such as modify negotiating practices, changing contractual terms, business practices, identifying commercial and other risks, monitoring counterparty performance, and many others.

### Descriptive Analytics

Descriptive analytics provides or presents various forms of historical data to enable users to determine or otherwise gain insights into past events. Such forms of analysis may be used to enable contracting parties to assess the performance of computable contracts (e.g. revenues, penalties, delivery delays in supply contracts, frequency rates of certain events occurring in contracts, real-time or near real-time execution and other performance metrics/data). Analysis may use data from the state of the contract along with any appropriate data from external systems. In the latter case, descriptive analytics may be used to show the effect of contracts and contractual events in real-time on external systems (e.g. Inventory Management Systems (IMS), Supply Chain Management (SCM) systems, Enterprise Resource Planning (ERP) systems, accounting/invoicing applications/systems, logistics systems, payments systems, and many others). Descriptive analytics may use such techniques as data aggregation and data mining to identify patterns and relationships in data.

### Diagnostic Analytics

Diagnostic analytics may be used to gain insights with respect to contract events and performance. Techniques may include (but are not limited to): drill-down, roll-up, data discovery, data mining, regression modeling, and correlations. Contract diagnostics are particularly applicable for analyzing causation between contractual events. Data may be internal to the contract (e.g. price changes resulting from a penalty) or external (e.g. data relating a late delivery that resulted in the price change, or a transaction representing the change in ownership of goods on a BDL). Examples may include (but are not limited to): insights into the cause of contract events (e.g. why was a penalty levied) and may occur across contracts.

### Predictive Analytics

Predictive analytics preferably generate a predicted future state of a contract corpus, which may include predictions on future state of one or more contracts. Predictive analytics may be used to predict state changes of a contract, predict when different states of a contract will take effect, if or when contracts will be breached and how, or other suitable predictions. Predictive analytics include statistical techniques from predictive modeling (e.g. geospatial predictive modeling), regression techniques, machine learning (e.g. neural networks, Radial Bias Functions, Support Vector Machines, Multilayer Perceptron etc.). Data mining that analyzes historical data is combined with rules, algorithms, and occasionally external data to determine the probable future outcome of an event or the likelihood of a situation occurring. Predictive models exploit patterns found in historical and transactional data to identify risks and opportunities. Examples of predictive analysis methods as applied to contracts may include (but are not limited to) counterparty analysis and event analysis. These methods may also utilize predictive modeling to support scenario-based analytics and modeling (e.g. ‘what-if’ modeling), in which the system will show the predicted status outcome of the contract clause, contract and a defined corpus of contracts (e.g. all contracts, all supply contracts, all contracts in effect after a given date, contracts linked in a given way, etc.) based on user inputted scenarios. The modeling will preferably use the same learnt models in combination with the hypothesized data and events. ‘What-if’ modeling may be performed on for individual contracts, or for contract corpuses.

Counterparty analysis methods of predictive analysis may be applied to historical counterparty and performance data to predict the manner in which contracts will likely be performed. This analysis may be used to select counterparties based upon necessary business goals in any given situation (e.g. where transactions are driven by certain metrics over others, such as price, timeliness, performance levels, etc.).

Event analysis methods are used in predicting the effects of various events on: (a) the state of a contract or corpus of contracts (including linked contracts) and (b) the enterprise. For example, financial and inventory implications of logistics delays under contracts caused by weather patterns using geolocation and shipment data. Similarly, the implications for the enterprise may be modeled. As the system collects more historical data for each of the data elements and events, and the system records the response of the contract in the form of each single clause status as well as the overall contract and contract portfolio status, a group of machine learning models will be learnt (including, but not limited to those aforementioned). The generated model may be tested against new data and events to assess the accuracy and suitability of each model at the different level in predicting the status of the contract clause, the contract and the contract portfolio. Subsequently, the system will utilize the models to present predictive analytics with a superior accuracy supporting current trend projections on the status of a contract clause, contract, and/or corpus of contracts.

### Prescriptive Analytics

Prescriptive analytics functions to provide decision options to take advantage of the results of descriptive and predictive analytics, such as taking advantage of a future opportunity or mitigating a future risk. Prescriptive analytics preferably involves generating a recommendation of one or more decision options. Predictive analytics may additionally show the implications of each decision option. Prescriptive analytics contract data may be used alongside data from external systems such as IoT platforms (and associated analytics systems), cognitive intelligence systems, and other enterprise systems (e.g. IMS, SCM, ERP) to perform prescriptive analysis. The purpose of prescriptive analytics is to give decision options to take advantage of the results of descriptive and predictive analytics such as to a future opportunity or mitigate a future risk and shows the implications of each decision option. The prescriptive analytics functionality of the system and method may continually re-predict and re-prescribe based on external data exposed to the analytics engine(s). Examples of prescriptive analytics, as applied to contracts, are (but are not limited to): optimization of terms and conditions and contract action suggestions. Optimization of terms and conditions uses historical data and current data about the state of an enterprise and existing contracts (e.g. performance completion, liabilities, exposure, real-time finances, etc.) to prescribe optimal or recommended terms and conditions for negotiating the terms and conditions of contracts. This may include the substance of terms and conditions, as well as the timing of contracts (e.g. when to purchase certain goods based on past fact patterns, external data, etc.). For example, a recommended term or condition option may be presented to a user within a contract creation/editing flow, within a contract template, during contract negotiation, contract amendment process, or during other suitable times. Other examples include (but are not limited to): prescribing the specifications of goods or services to be delivered based on data about the how such deliverables may be utilized, the scope and limits of warranty and indemnity clauses based on past coverage triggers, and the manner of delivery, acceptance, and storage of goods based on recent logistics data. Contract action suggestions uses predictions to suggest optional contract-based actions and their respective implications. For example, termination or purchase order analysis based upon forecast in market prices, data pertaining to contract-related risks (e.g. weather, logistics, supply/demand forces), etc.

A business rules engine or similar may be used to automate or otherwise perform certain operations, such as the execution of internal events to terminate contracts based on analysis. For example, reprising a supply agreement, if based upon analysis such a supply contract is not validly terminable but the current penalty that would be incurred is less than the projected loss in revenue that will likely arise based upon the current corpus and prices that are typically charged by a supplier to supply goods before inventory is projected to drop below a stipulated level based upon the corpus of contracts).

### Analysis of Distributed Ledger Related Data

Analyzing contract related data S130 on blockchains/distributed ledgers enables data that is not stored by the off-chain element of a contract to be included in a holistic analysis of the state of a contract or corpus of contracts (e.g. either because the contract does not store data that is related to the contract, or it does store such data—such as the existence of a transaction that was performed under, or otherwise related to, the contract, but additional data is required that is not stored, such as relationships between transactions, metadata, etc.). Examples of data that may be used in contractual analysis include (but are not limited to): (a) details pertaining to the status of a transaction (e.g. whether a transaction has been executed, when it was executed, etc.) which may be a financial or any other transaction or status of data that was appended to a blockchain/distributed ledger (e.g. of a shipment in a supply chain); (b) details pertaining to the status of ‘on-chain’/‘on-ledger’ script/code (e.g. when it was deployed, if it has been invoked, when it was invoked, by which addresses, linked scripts/addresses, etc.); (c) formal identification of the involved parties in the contract via their blockchain identification; and (d) formal identification of agreed upon off-chain’ data sources. Analyzing BDL state may be done using various approaches including (but not limited to): neural network representation, pattern recognition of transactions between parties, state machine representation, and support vector machine learning model. A neural network representation involves mapping ledger transactions into neural network nodes allowing the generation of predictive data. Pattern recognition of transactions between parties involves statistical analysis of the data using established patterns to determine future trends. A state machine representation involves creating a state machine based on the current status. The state machine will be limited to a finite list of states in order to reduce the complexity of the system and provide fast response. A support vector machine learned model involves learning a support vector machine (SVM) model from past relevant chain transactions allowing the prediction of future trends. Additionally and alternatively, data on BDLs may be analyzed separately. For example, data may be in the form of: (a) on-chain/on-ledger code that operates as programmable clauses; (b) on-chain/on-ledger code that is used by programmable clauses to perform various transactions; (c) data that is input to (e.g. IoT data instantiated on a BDL) or output from contracts (e.g. transactions that are executed by the contract logic on blockchains/distributed ledgers); and (d) transactions instantiated on a BDL from other sources (e.g. business network applications, other applications, etc.).

### Analysis Through Graph Structure

In the variation where a graph data structure is used, a Graph Processing Engine (GPE) may be used in analyzing the contract related data S130. A variety of graph, network, and other algorithms may be used that process the graph to extract analytics and deep insights into underlying data pertaining to both contracts and their context. Different algorithms may be used for different purposes in extracting and analyzing data. Examples of such algorithms may include (but are not limited to): Connected-Component Labeling; Label Propagation; Depth-first Search; Breadth-first Search; Union Find; Betweenness Centrality; Degree Centrality; Single-relational Graph Centrality; and Closeness Centrality. Data from the graph may be used for a variety of applications, as aforementioned.

Use of a graph data structure enables the relationships between objects that represent the contract, contract state and performance, and any related operations/events to be determined. These relationships in the graph structure can be queried to provide data and metadata on the relationships between the contract objects. The graph may be queried in a number of ways, including (but not limited to): (a) API and (b) using a SQL-based (or other) query language. Graph analytics can be performed to provide: insights into contractual state (e.g. what happened and why), risk modeling and predictive analytics (what would happen if a given event occurred under the logic of the contract to one or more contracts, including ‘linked’ contracts), and a variety of other applications. As contracts embody relationships between parties, the graph data structure and graph analysis may be used to analyze the state of those relationships. This may be used to identify sub-relationships or groups of related contracts. From there, relationships between contracting parties may be analyzed, as well as relationships between contracts themselves. In one application, the graph data structure may be traversed, replayed, and predictively modeled to provide insights as to what would/may have occurred in a contract or across a corpus of contracts. The data from the graph may also be passed to ‘on-chain’/‘on-ledger’ script/code, added to BDLs (e.g., as on-chain objects, within transactions, etc.), and any other external data source or database.

The graph processing engine may operate on a distributed basis or may operate locally. In the former, the GPE preferably organizes the main memory of a cluster of machines as a globally addressable address space to store large scale data sets; as a computation engine. The GPE make take any suitable form, but is preferably comprised of: a distributed key-value store, a specification language, and APIs. The distributed key-value store is preferably supported by a memory storage module manages the main memory of a cluster of machines and provides mechanisms for concurrent control. The specification language may be used instead of a fixed graph schema and fixed computation models to specify graph schemata, communication protocols, and computational paradigm. APIs may be used to implement graph processing logic and to expose data (e.g. expose data to a contract management platform or system). Additional and/or alternative components may be used in a given implementation of the GPE.

### Machine Learning Analysis

In one embodiment, machine learning algorithms and techniques (such as those mentioned above) may be used in conjunction with business rules to automate the performance of certain actions/operations based upon learned actions performed by users or suggest actions based upon the state of enterprise data. A business rules management system (BRMS), business rules engine (or similar) may be used to perform operations or actions with respect to contracts based on the output of the analytics engine. In this variation, the method may include automating a computer-driven action in response to a business logic rule that is based on contract related data and/or analysis of the contract related data. Actions may be performed in coordination with block S140 or separately. Taking the aforementioned example of a supply contract, an example of BRMS actions/operations may include increasing the size of a purchase order under a contract where inventory levels of a particular item are low or demand is projected to increase (e.g. based on the state of the enterprise per the analytics output, ERP data, other contracts, etc.). Another example of BRMS action/operation may be exercise of termination of the contract, such as where an event (e.g. breach of a condition) occurs that creates a right of termination per the logic of a contract. Using enterprise data to assess the suitability of exercise of termination (e.g. what effect will it have on other contracts inventory levels, etc.) or the most beneficial remedial action based on the current and/or projected state of the enterprise may be taken, which could be termination of the contract. Numerous other applications are possible.

### Visualizing Contract Related Data

Block S140, visualizing the contract related data and the analysis of the contract related data, functions to report data, predictions, and recommendations about the contract. More generally, block S140 can be the application of the analysis of the contract related data in a variety of use cases. Data presented may preferably include state value of the contract and any other current data regarding the contract. In addition, block S140 may present all analysis information that is known about the contract. Data presented may be literally presented visually in entirety, over a user interface, but may additionally or alternatively present or communicate data to an automated system that may be managing the contract.

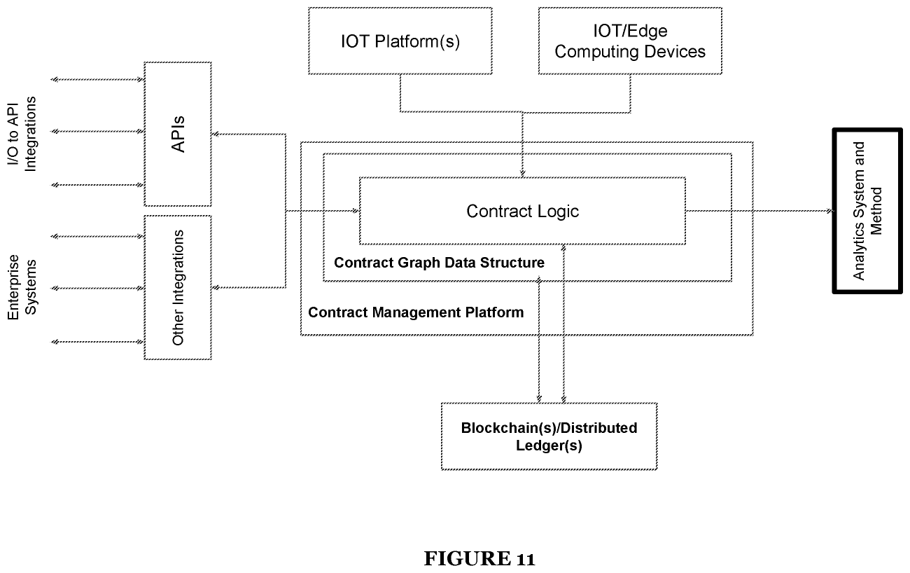

Visualizing contract related data S140 may include visualizing related data and analysis of data for a contract corpus. A variety of different forms of reporting and data visualization may be used in any given embodiment, including (but not limited to): information graphics, statistical models, descriptive statistics, inferential statistics, tabular data, and other forms. At least some of the data visualization is preferably interactive; enabling a user to modify visualizations. In a preferred embodiment, a data visualization application forms a component of a multi-tenant cloud-based platform—which may be a contract management platform or system as shown in FIG. 11. Alternatively, it may (in whole or part) take the form of a decentralized application, serverless, or distributed contract management platform. The contract management platform preferably enables users to manage the entire contract management lifecycle from drafting and negotiation through to management, renewal, and analysis. The contract management platform is preferably accessible by permissioned user access. Data may be accessible via desktop based applications, smartphone applications, or other appropriate means. Data may be exported to other systems or applications and/or reports (either static or dynamic) may be produced. In a preferred embodiment, the of data visualization may be comprise of (but are not limited to): contract dashboards, aggregate dashboards, display feeds, notification engine, graph visualizations, blockchain/distributed ledger specific parser display, “live”-stats, embedded indicators/icons, and/ or suggestions. Other data types, forms, and subjects may be used in a given implementation. All, any, or none of the above may be used in a given embodiment, and may be used in conjunction with other forms, types, techniques, methods/mechanisms, and sources of data visualization.

### Contract dashboards

Contract dashboards may be a type of data visualization. Contract dashboards display charts, graphs, values, and other metrics and analytics that are specific to each contract. For example, a contract dashboard for a supply contract may display the price of the contact as it over time, geolocation of a shipment, relevant IoT sensor data monitoring shipping conditions, relevant data from external systems/applications (e.g. accounting data, calendar dates/event data, web services data, transaction data from payment systems, data and transactions from BDLs, relevant ERP/IMS/CRM systems data, events/operations performed on external resources, etc.), metrics around breaches of clauses and penalties, feeds of events that have occurred under a given contract or specified group of contracts, payments that have been made under contracts, notifications sent to appropriate persons as discussed above, and other relevant communications and data. Additional and/or alternative data may be displayed.

Aggregate dashboards may also be a form of data visualization. Aggregate dashboards display charts, graphs, values, and other metrics and analytics that aggregate data across all contracts or a corpus of contracts. Such data may be returned by filtering datasets, defining parameters, and other means of configuration. Machine learning techniques may be used to filter and/or display the most appropriate data to users based upon the current state of contracts, contract activity, and anomalies.

Where a GUI dashboard is used, data may be preferably displayed through a series of configurable, modular, widgets. Configurable widgets enable the user to customize data visualization to meet the user's requirements and preferences. Each user may be able to customize the dashboards to their own requirements; even when two or more users operate on behalf of the same organization. This way each user dashboard is enabled to display the most appropriate data for the appropriate user, as since data of interest may be not be the same for all users within a given organization or even multiple organizations. For example, a user performing a financial function is unlikely to require all of the same data as users performing operations or legal functions.

### Contract Corpus

Visualizing contract related data S140 for a contract corpus may present additional details. Contract corpus dashboards may preferably present analytics and then include ability to navigate and inspect individual contracts, or subgroups of contract corpus, embodied by the contract corpus. This visualization may be customizable, allowing users to potentially define new meta-contracts, real time, by choosing different contract corpus subsets from all the available stored contracts within the system. This would then enable analyzing and visualizing of different data subsets thereby initiating additional instances of blocks S130 and S140.

### Data Types

Types of data that may be displayed, either on a contract or aggregated dashboard level, may include (but are not limited to): negotiation analytics, performance analytics, predictive analytics, relationships between contracts and contract relations, comparisons of counterparty performance, and links between any of the aforementioned data types.

Negotiation analytics may be a displayed data type. Negotiation analytics uses data stored about the past and current state of the contract (e.g. from the graph and other sources) to determine negotiation patterns. Examples may include (but are not limited to): most negotiation clauses and negotiated deviations (e.g. from proposed terms and conditions, standard terms and conditions, policy guidelines, etc.).

Performance analytics may be a displayed data type. Performance analytics includes data relating to contract performance (e.g. penalties applied, current revenue and payments based upon the state of contracts, deliveries under supply agreements, and causation between events, such as the cause of penalties. Performance analytics may include using external data to display more contextualized data to users. For example, a supply agreement may include data from inventory management systems (IMS) to show the projected stock levels at given dates based upon deliveries under supply agreements.

Predictive analytics may be a displayed data type. Predictive analytics functionality may be used to forecast the future state of contracts based upon historical and new data. Examples of historical and new data may include, the current and past state of a contract or corpus of contracts, the state of the physical world (e.g. weather conditions), and/or data from external systems (e.g. delivery tracking). Predictive analytics involves applying statistical analysis techniques, analytical queries, and automated machine learning algorithms to data sets to create predictive models that place a numerical value, or score, on the likelihood of a particular event happening.

Relationships between contracts and provisions in contracts may be a displayed data type. Relationships between contracts functions to show intra-contract relationships, between provisions within a contract, and inter-contract relationships. For example, if an event (e.g. a penalty) occurred under Contract A, the effect that has that had on Contract B may be analyzed. For example, a penalty applied under one contract may be as a result of a breach of another contract for which compensation may be claimed. The same may occur in intra-contract (e.g. between clauses in the same contract). Data concerning these interrelationships may enable users to more efficiently and effectively manage a corpus of contracts.

Comparison of counterparty performance may be a displayed data type. Comparison of the performance of counterparties depending upon the links between any of the aforementioned visualized data sets, enabling deeper insights into contractual performance (e.g. counterparty performance metrics relative to negotiated deviation).

### Visualization Type Variations

In one variation, Block S140 can include displaying feeds. Feeds may chronologically present: events, notifications, transactions, operations, and other actions that occur under contracts, or are otherwise of relevance and/or pertain to contracts and contract performance. Feeds may aggregate all actions, operations, notifications, transactions, and events that occur under one or more contract. Separate feeds may be available for each contract. Aggregated feeds may preferably be used in addition. Events may be aggregated so that all users of a given organization see all events, or filtered according to various parameters (e.g. job function, contract signatory, organizational department, etc.). Feeds may also be filterable by event/action/notification type, source, date/time, or other appropriate parameters/filters. Feed data may be pushed via API to external systems (e.g. work-based chat/communication systems, IRC, other dashboards, etc.). Alternatively, or in addition, webhooks or any other appropriate mechanism may be used. Notifications/events may be permissioned so that only certain users may view certain types/sources of data.

In one variation, Block S140 can include initiating a notification. Initiating a notification may direct a notification engine in sending push notifications to users when events occur under a contract or otherwise pertaining to a contract. Notifications may be sent to users to inform them of operations that have occurred, may occur, or are due to occur, with respect to a contract. An operation may include any event, change, update, transaction, data transfer or any other appropriate operation that occurs in respect of one or more contracts. Notifications may therefore relate to (but are not limited to): events, updates, transactions, advisory notifications (e.g. to provide information on potential contractual interrelationships affected by an operation), or any other operation. Notifications may be user configured and may use machine learning technologies to push relevant notifications. The Notification Engine may also be used to provide notifications that: (a) may pertain to more than one contract (e.g. where an event that occurs under one contract may impact, affect, or otherwise have relevance for another contract or contracts) and/or (b) notifications of events that occur under one or more contracts that may impact, affect, or otherwise have relevance for other systems within the enterprise (e.g. when goods in supply contracts are delayed that may have an adverse effect on supply chain management, inventory level management; or the effect of a penalty on a contract on financial systems and financial regulation metrics, etc.). As well as being displayed in a contract management platform (e.g. in a feed and/or pop-up notifications), notifications may also be pushed via APIs or webhooks to other systems, such as (but not limited to): work-based chat/communication applications, email, SMS, Internet Relay Chat (IRC), workflow automation tools, data aggregation tools, and many others. Notifications are preferably assignable to specific persons/users within a team/organization, specific teams/departments within an organization (e.g. finance, legal, supply chain, IT, operations, management, etc.), as well as external persons, entities, organizations, and third parties (e.g. outside counsel, members of a supply chain, regulators, financiers in trade finance transaction, outsourcing providers/contractors, etc.). Notifications may be displayed by pop-ups, toasts, banners, or of any other appropriate type. Notifications may display text, figures, graphics (e.g. charts, tables), or any other appropriate medium. Notification frequency, delivery type, form/style, content, and other attributes may be configured by users in any suitable form (e.g. through a contract management platform).

In one variation, Block S140 can include graph visualizations. Graph visualizations may display data relevant to contracts. Graph visualizations may be displayed in a visualization of graph structures or any suitable type of information. This enables users to graphically view relationships between data: (a) within each contract; (b) between different contracts; and (c) between contracts and external data sources and systems.

In one variation, Block S140 can include presenting a BDL specific parser display. The BDL specific parser display may be preferably used when one or more BDLs are used in a given embodiment (e.g. to perform transactions on, store data such as state objects or hashes on, as a data source to the contract, etc.). The data on such contract systems may be parsed, collated/organized, and displayed in a number of ways. For example, a real-time or near real-time dashboard may display tables/logs of transactions, ledger/account addresses, distributed ledger state, unspent transaction outputs (UXTOs), transaction details, pertinent metadata, related contract details, and the like.

In one variation, Block S140 can further include presenting live stats. Live stats, in addition to dashboards, may be used to provide real-time or near real-time values, providing insight into the state of contracts and contractual metrics for users. Live stats may be applicable to one contract or multiple contracts. Examples may include (but are not limited to): price changes, revenue, projected surplus/shortfall of supply, incurred penalties, projected penalties, credits/discounts issued, performance levels, delivery/logistics status, etc. Data may be displayed by graphs, tickers, tables, charts, graphical images/iconography, and any other appropriate means.

In one variation, Block S140 can include embedding indicators. Embedded indicators/icons may be embedded within the text of clauses where the text of a contract is viewed on the contract management platform. Indicators/icons may be embedded within the text of clauses, adjacent to the text of the contract or otherwise associated with it (e.g. by way of ‘roll-over’/‘pop-up’). For example, up/down arrows and/or trend lines may be embedded next to numerical values (such as price, quantities, times, durations, uptime, etc.) to depict whether a value has changed and how. Similarly, a color coding system may be used to depict importance/severity of an issue, event, status, or similar within the contract (e.g. a delayed delivery under a contract that is unlikely to be delivered as per the contract requirements may result in the relevant clause or part thereof being highlighted according to the color coding system).

Visualizing contract related data S140, can include suggesting predictive and analytic functionalities. Suggestions may be displayed through a user interface using the aforementioned predictive and prescriptive analytic functionalities. In a preferred embodiment, the user interface depicts the current state of the contract, the future predicted state of the contract, and the reason for the suggested course of action. This data may be displayed in tabular, graphical, or other appropriate form. Alternative combinations of visualized data may be displayed.

Visualization of the contract related data S140 may further directly feed information into a contract automated system. This automated system may be a local automated system, on- or off-chain, or maybe a general system for a contract automated library management system. The automated system may preferably have permission and ability to change parameters and contract state. Using predictive information that is provided by the report of the contract analysis, the contract automated system may make changes to the contract, any may additionally change external contract related states (if possible). Concurrent to the functionality of the automated system, notifications and other information details may be produced through visualizing of the contract related data. The automated system may additionally function for a contract corpus in the same manner as for individual contracts. Machine learning techniques may additionally be implemented with the contract automated system.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system for managing data state across linked electronic resources comprising:
database storage comprising a set of electronic resources that are programmatically integrated with external data sources, wherein the electronic resources comprise:
natural language content;
at least one programmable component that comprises computer executable instructions that define:
one or more state objects that indicate compliance with the natural language content; and
a logic component that programmatically changes, based on resource input through application programming interface (API) communication with an external digital data system, one or more state objects;
one or more attributes describing the electronic resource; and
one or more processors configured to:
determine, based on the one or more attributes, a subset of the set of electronic resources having at least one relationship;
retrieve values from state objects from the subset of the set of electronic resources, wherein retrieval comprises extraction of electronic resource associated API related data based on logic of an electronic resource;
aggregate state objects and API related data into a graph data structure;
compute, based on the one or more state objects and the graph data structure, a visualization data set describing the subset of the set of electronic resources; and
render, based on the visualization data set, a visualization.
